(19) United States
(12) Patent Application Publication
(10) Pub. No.: US 2024/0428162 A1
(43) Pub. Date: Dec. 26, 2024

(54) SYSTEMS AND METHODS FOR A FRAMEWORK FOR CYBER RISK LOSS DISTRIBUTION OF CLIENT-SERVER NETWORKS INCLUDING A BOND PERCOLATION MODEL

(71) Applicants: Stefano Chiaradonna, Tempe, AZ (US); Petar Jevtic, Chandler, AZ (US); Nicolas Lanchier, Gilbert, AZ (US); Sasa Pesic, Petrovaradin (RS)

(72) Inventors: Stefano Chiaradonna, Tempe, AZ (US); Petar Jevtic, Chandler, AZ (US); Nicolas Lanchier, Gilbert, AZ (US); Sasa Pesic, Petrovaradin (RS)

(73) Assignee: Arizona Board of Regents on Behalf of Arizona State University, Tempe, AZ (US)

(21) Appl. No.: 18/745,893

(22) Filed: Jun. 17, 2024

Related U.S. Application Data
(60) Provisional application No. 63/508,444, filed on Jun. 15, 2023.

(51) Int. Cl. G06Q 10/0635; H04L 9/40

(52) U.S. Cl. CPC G06Q 10/0635; H04L 63/1466

(57) ABSTRACT

A system including at least one processor is configured for executing a mathematical contagion model based on percolation theory to anticipate the loss distribution resulting from a cyberattack on a class of client-server network architectures with K different client types. The system includes a framework that computes the exact mean and variance of the losses depending on key parameters such as probabilities of attack types, the topology of the network of clients, and contagion strength among the clients. This framework can be used by insurance companies to estimate the liability assessments of insuring a given IT network against the damages that may arise from cyberattacks, including the losses of company revenue, and improved decision-making in cybersecurity protection investments of the network. Further, the framework provides insights into better investment strategies for cybersecurity protection on the client-server network.

### CROSS REFERENCE TO RELATED APPLICATIONS

This is a non-provisional application that claims benefit to U.S. Provisional Application Ser. No. 63/508,444, filed on Jun. 15, 2023, which is herein incorporated by reference in its entirety.

### GOVERNMENT SUPPORT

This invention was made with government support under 2000792 awarded by the National Science Foundation. The government has certain rights in the invention.

### FIELD

The present disclosure generally relates to cyber technologies and threat response; and in particular, to a computer-implemented framework including a mathematical contagion that anticipates loss distribution resulting from a cyberattack on a class of client-server network architecture with K different client types.

### BACKGROUND

Risk management and decision-makers increasingly face decisions that stem from the following questions: How does the cybersecurity protection of my business's information technology systems impact my losses? And, what price-effective investment strategies in cybersecurity protection help reduce my potential liabilities? According to The Institute of Risk Management (2018), cyber risk is defined as “any risk of financial loss, disruption or damage to the reputation of an organization from some sort of failure of its information technology systems.” And precisely due to this emerging risk, businesses and their clients are increasingly suffering from severe financial losses, disruption of operations, legal fines due to permanent data loss, etc. (IBM Security, 2020; NetDiligence, 2019) Many factors affect the scale of a business's losses due to cyber risks, such as a business's information technology (IT) network (Da, Xu, & Zhao, 2021) and cybersecurity levels (Eling, Jung, & Shim, 2022). To account for these factors, the cybersecurity environment of a business can be viewed as the structural properties and network management of a business's implementation mitigating cyber risk. Thus, viewed in this way, the cybersecurity environment as a conceptual tool immediately implies the need for a more comprehensive assessment of a business's cybersecurity protection strategies. Therefore, to have clear cyber risk assessments and make informed decisions on investments in cybersecurity protection on a fixed budget, risk managers need frameworks that account for their IT networks and unique cybersecurity environments.

It is with these observations in mind, among others, that various aspects of the present disclosure were conceived and developed.

### BRIEF DESCRIPTION OF THE DRAWINGS

The present patent or application file contains at least one drawing executed in color. Copies of this patent or patent application publication with color drawing(s) will be provided by the Office upon request and payment of the necessary fee.

FIG. 1 is a visualization of the random process of the K-client type of client-server random graph for a single contagion and associated costs as described herein.

FIG. 2 is a set of graphs illustrating expectation and deviation of loss as a function of the probability p toward the CIEDs for various values of the probability q away from the CIEDs. The cost distributions are from Table 1 with assumptions t=1 and λ=1. Additionally, the probability of the hospital being the origin of the contagion is fixed with r=0.2.

FIG. 3 is a set of graphs illustrating the expectation and deviation of loss as a function of the probability r of the BMS being the origin of the contagion for various values of the probability p(q) with fixed probability q=0.4 (p=0.4). The cost distributions are from Table 3 with assumptions t=1 and λ=1.

FIG. 4 is a set of graphs of the expectation and deviation of continuous loss due to hourly downtime due to disruption of business operations for various values of the probability p(q) with fixed probability q=0.4 (p=0.4). The cost distributions are from Table 4 with assumptions t=1 and λ=1. The probability of the service provider being the origin of the contagion is fixed with r=0.6.

FIG. 5 is a set of graphs of the expectation and deviation of loss for the number of vehicles vulnerable to cyber risk and various values of the probability p(q) with fixed probability q=0.4 (p=0.4). The cost distributions are from Table 5 with assumptions t=1 and λ=1. The probability of the central unit being the origin of the contagion is fixed with r=0.8.

FIG. 6 is a simplified illustration of a system/framework for implementing the inventive concepts described herein.

FIG. 7 is an example method and/or computer implemented process associated with the inventive concepts described herein.

FIG. 8 is a simplified diagram showing an exemplary computing device that may be implemented with the inventive concepts and configured to perform functions described herein.

Corresponding reference characters indicate corresponding elements among the view of the drawings. The headings used in the figures do not limit the scope of the claims.

### DETAILED DESCRIPTION

The present inventive disclosure related to various embodiments of a computer-implemented framework including a model contagion that anticipates loss distribution resulting from a cyberattack on a class of client-server network architecture with K different client types.

Cyber risk has emerged as a significant threat to businesses that have increasingly relied on new and existing information technologies (IT). Across various businesses in different industries and sectors, a distinct pattern of IT network architectures, such as the client-server network architecture, may, in principle, expose those businesses, which share it, to similar cyber risks. Accordingly, a probabilistic structural framework for loss assessments of cyber risks on the class of client-server network architectures with K different client types is presented. It is believed no theoretical models of an aggregate loss distribution exist for cyber risk in this setting. With this structural framework via the exact mean and variance of losses, it is demonstrated how the changing cybersecurity environment of a business's IT network impacts the loss distribution. Furthermore, the inventive framework provides insights into better investment strategies for cybersecurity protection on the client-server network. Motivated by cyberattacks across industries, the framework is applied to four case studies that utilize the client-server network architecture. The first application is implantable medical devices in healthcare. The second application is the smart buildings domain. Third, an application for ride-sharing services such as Uber and Lyft is presented. The fourth is the application of vehicle-to-vehicle cooperation in traffic management. The results are corresponding exact means and variances of cyber risk loss distributions parameterized by various cybersecurity parameters allowing for liability assessments and decisions in cybersecurity protection investments.

### 1. Introduction

Risk management and decision-makers increasingly face decisions that stem from the following questions: How does the cybersecurity protection of my business's information technology systems impact my losses? And, what price-effective investment strategies in cybersecurity protection help reduce my potential liabilities? According to The Institute of Risk Management (2018), cyber risk is defined as “any risk of financial loss, disruption or damage to the reputation of an organization from some sort of failure of its information technology systems.” And precisely due to this emerging risk, businesses and their clients are increasingly suffering from severe financial losses, disruption of operations, legal fines due to permanent data loss, etc. (IBM Security, 2020). Many factors affect the scale of a business's losses due to cyber risks, such as a business's information technology (IT) network (Da et al., 2021) and cybersecurity levels (Eling et al., 2022b). To account for these factors, we view the cybersecurity environment of a business as the structural properties and network management of a business's implementation mitigating cyber risk. Thus, viewed in this way, the cybersecurity environment as a conceptual tool immediately implies the need for a more comprehensive assessment of a business's cybersecurity protection strategies. Therefore, to have clear cyber risk assessments and make informed decisions on investments in cybersecurity protection on a fixed budget, risk managers need frameworks that account for their IT networks and unique cybersecurity environments. And so when it comes to a business having IT client-server architectures, our paper paves the way in this context.

Losses. When one looks closely at cyber risk losses over time, it is apparent that cyber risk has experienced significant growth leading to great financial losses. In 2016 alone, cyberattacks cost the U.S. economy between $57 billion to $109 billion (The White House, 2018). Moreover from 2020 to 2021, the cost of a data breach due to a single cyberattack has risen from $3.86 million to $4.24 million (IBM Security, 2020). The relevance of cyber risks and their disruptive impacts have been seen across both public and private sectors. When it comes to the private sector, a single cyberattack can have significant repercussions. One recent and disastrous example is the cyberattack on the Colonial Pipeline Company in 2021, where the company had to temporarily shut down the main pipeline to the entire U.S. East Coast disrupting the country's economy (Bowden, 2021). Overall, these losses can take various forms. Businesses have to pay massive settlements from legal fines due to data loss of customer records (IBM Security, 2020). An explicit example is a recent settlement in December 2021 with Capital One Financial paying $190 million due to a cyberattack in 2019 compromising over 100 million customers' personal data (The Washington Post, 2021). And with a 31% increase in the frequency of cyberattacks from 2020 to 2021 (Accenture, 2021), it seems quite unlikely that losses due to cyber risk would wane in the upcoming years.

Risk management and mitigation. Businesses have increasingly demanded cyber insurance as a solution to cyber risk (American Academy of Actuaries, 2022). From 2016 to 2019, the amount of total direct written premiums increased from $2.1 billion to $3.1 billion (United States Government Accountability Office, 2022). However, price-effective cyber insurance coverage may not be available for all the circumstances a business may encounter, especially given the business's size (United States Government Accountability Office, 2022). Even if available, cyber insurance may not be able to cover all the damages incurred by the business and its clients from a cyberattack. Therefore, cyber insurance may be an inadequate solution for all business circumstances. However, it can be a component of a broader risk management strategy for cyber risk (Federal Financial Institutions Examination Council, 2018). Thus, it is clear that management and decision-makers need to include other solutions as components of their risk mitigation strategies to reduce their overall cyber risk exposure and consequently reduce their losses from cyberattacks.

Modeling challenge. Unfortunately, there is a great lack of analytical tools for quantifying cyber risk. Most prior works provide great insights into cyber risk and its mitigation strategies by analyzing data from past cyberattacks (Biener et al., 2015; Eling et al., 2022b). However, there needs to be time for losses to become fully realized to solely rely on historical data, especially accounting for particularities such as industry sector and business size. This makes it difficult for risk managers to apply their known risk management strategies, which may have worked for other types of operational risks, to cyber risk. As described by Da et al. (2021), cyber risk is intimately interconnected with the information and communication technologies of a business's IT network. As businesses continuously adjust to technological changes by adding or removing software and adapting employee structures, the distinct characteristic of cyber threats lies in their constant evolution and changing tactics (see e.g. Violino (2022)). Moreover, the impacts of a cyberattack deviate notably from those associated with other operational risks. The interconnected and swiftly evolving nature of technology introduces ever-changing vulnerabilities to a business's IT networks. The potential fallout from a cyberattack can be substantial, encompassing data breaches, financial losses, and reputational damage (Chiaradonna et al., 2023). Therefore, to address this issue, risk managers need to substantially include the cybersecurity environment of the business's IT network and the integrated technologies as components of their risk mitigation strategy.

As a component of a broader risk mitigation strategy, investment in cybersecurity protection such as timely patching of systems and responsible communication management can help mitigate losses (August et al., 2022). However, according to the survey by Kissoon (2020), many decision-makers and managers believe that their current fixed cybersecurity budgets are insufficient and their cybersecurity strategies are ineffective. Therefore, this poses a serious problem for managers to decide on price-effective cybersecurity investments and on how best to implement them within fixed budgets. One low-cost investment is to identify the type of IT network their business is using.

IT network. One distinct pattern of IT network architectures across sectors and businesses is the client-server network architecture. At its core, a traditional client-server network architecture involves clients, such as individual computers, that are connected to a centralized server, such as a data center, to act as an intermediary between clients (Wu, 2015). Other interpretations of the client-server network architecture are of several smartphones connected to a centralized service provider (Mohamed et al., 2017). And another example is fire alarms in buildings connected to a centralized building management system (Peacock et al., 2017). With this in mind, the client-server network architecture is found across various sectors such as in healthcare (Tanwar et al., 2020), transportation (Baza et al., 2020; MacNeille et al., 2018), and commercialized buildings (Bandara et al., 2016). This shared distinct pattern of IT network architectures may expose different businesses to similar, in principle, cyber risks.

Inventive Solution. To gauge the impact of cyber risk, a framework that uniquely incorporates a business's IT network and various investments in cybersecurity protection was construed and is described herein. In particular, a structural framework for loss assessment for cyber risk on the class of client-server network architectures is proposed with K different client types. We model the client-server network architecture and thus a business's IT network as a random graph. We refer to Lanchier (2017) for an in-depth introduction to random graphs. We use a two-parameter bond percolation model as the contagion model of a cyberattack. Bond percolation was introduced in Broadbent and Hammersley (1957). For a thorough introduction to bond percolation, we refer the reader to Grimmett (1999). We adopt bond percolation primarily because of its intimate connection to the cybersecurity environment of an IT network (Moore and Cho, 2019). This allows us to study the evolution of a cyberattack on a constantly evolving network. The different IT asset types, represented as nodes in a random graph, on a business's IT network is a crucial characteristic to consider since some IT assets may yield greater losses if infected. To account for this liability feature, we consider a configuration of monetary assets on the IT network i.e. we attach a certain dynamic value, represented via distributions, of cost to each IT asset in the network. This arrangement of cost distributions across the network constitutes a cost topology. The compromise of an IT asset in the network due to a cyberattack results in a monetary loss. As a result, the modeling framework proposed provides a liability assessment due to cyber risk.

The usefulness of the framework for liability assessment across different industries and businesses is demonstrated by applying it to four case studies with industry-specific costs. We then examine how differing investments in cybersecurity protection may mitigate losses for better risk assessment and help inform better management strategies. In totality, we provide a guide to risk professionals and policy-makers to help manage cyber risk and provide insights for cost-effective investment decisions in cybersecurity protection. In addition, the present disclosure describes straightforward pricing implications for cyber risk insurers.

The remainder of the present disclosure is organized as follows. Section 2 summarizes the related theoretical and applied literature on cyber risk. In Section 3, details associated with an example of the structural framework to model loss due to cyber risk of client-server network architecture with different asset types are provided and the main results of example applications are provided in Section 4. Section 5 presents the four case studies of client-server network architectures and applies the structural framework for each case study. Finally, example conclusions are set forth in Section 6.

### 2. Literature Review

The academic literature on modeling cyber risk has been steadily increasing over the years. As described by Da et al. (2021), the academic literature can be broadly categorized into two perspectives. The first is to model cyber risk at the macro-level by analyzing historical cyber loss data (see e.g. Maillart and Sornette (2010); Herath and Herath (2011); Biener et al. (2015); Chen et al. (2017); Eling and Jung (2018)). This has been a very popular perspective in actuarial modeling (e.g. by using copula and regression models Eling et al. (2022b); Mukhopadhyay et al. (2013); Peng et al. (2018)). However, it does not account for the spread of contagion on a network. That is why, the second is to model at the micro-level by considering a network model. This perspective has been gaining attraction since it can consider different technologies and cybersecurity protection that an organization may utilize.

The proposed framework falls in the micro-level perspective since it considers a specific type of IT network architecture found across various industries and businesses. From this perspective, there have been works for cyber risk management such as using attack graphs (Wang et al., 2013, 2018), epidemic models (Xu and Hua, 2019; Antonio and Indratno, 2021) and Bayesian models (Amin, 2019; Zebrowski et al., 2022). Other proposed models capture the unique cybersecurity features of fog networks (Zhang et al., 2023; Feng et al., 2018), while others utilize percolation theory for the cyber risk management of different networks. In particular, Jevtic′ and Lanchier (2020) introduced a dynamic structural model for loss distribution in small and medium-sized enterprises affected by contagious data breaches. In this model, the network topology is assumed to be a random tree, and attack arrivals follow a Poisson process. The authors provided exact expressions for the mean and an upper bound for the variance of the aggregate loss. Building upon this work, Chiaradonna and Lanchier (2022) expanded the percolation model to a bidirectional version, deriving exact expressions for both mean and variance of aggregate loss. Recognizing the significance of the first and second moments of compromise sizes in assessing cyber loss, there is exclusive research on these moments for specific network topologies. For instance, Chiaradonna et al. (2023) modeled the prototypical hospital network as a mixed random network, while Jevtic′ et al. (2020) modeled ring, bus, and star topologies. Juxtaposed to the aforementioned models, the proposed structural framework is unique in that it considers a specific class of applied IT network architectures found across various industries and businesses as well as extending the modeling architectures for random star topologies.

One of the main challenges of the percolation model on a random graph is computing the first and second moments of the size of the infected cluster on the random graph, which are the main components in calculating the mean and variance of the aggregate loss, respectively. For example, take the random-mixed graph outlined in Chiaradonna et al. (2023). When computing the second moment of the infected cluster size, the graph was treated as deterministic and homogeneous. This meant that the number of branches was fixed integers instead of the mean of a random number of vertices. This simplification was necessary due to the combinatorial complexity involved in calculating all self-avoiding paths of the infected cluster. Although distinct from a star graph, calculating the first and second moments on a random tree either leveraged complex combinatorial techniques, resulting in the upper bound of the second moment (Jevtié and Lanchier, 2020) or a different technique of using Galton-Watson trees and partitioning into disjoint subtrees to obtain the exact expression of the second moment (Chiaradonna and Lanchier, 2022). In either case, the network topology, particularly represented as a random graph, was one of the contributing factors in what techniques and approaches are necessary to find the first and second moments of the infected cluster size. Another is the number of percolation parameters of the model, making the model more realistic but also combinatorially more difficult to solve, especially on a random graph. That is why some works, assumed a deterministic graph, such as a deterministic star, with homogeneous node types with only one percolation parameter to obtain the first and second moments of the infected cluster size (Jevtié et al., 2020). Therefore, this work's methodological contributions are finding the exact first and second moments of the infected cluster sizes, and the exact mean and variance of the loss distribution, on a bidirectional percolation model of a random star graph with K-different node types. Furthermore, as a practical tool for practitioners, our framework quantifies the exact aggregate loss distribution for cyber risk on the class of client-server network architectures with different types of clients with industry-specific costs.

### 3. Inventive Framework: Stochastic Modeling of Cyber Risk

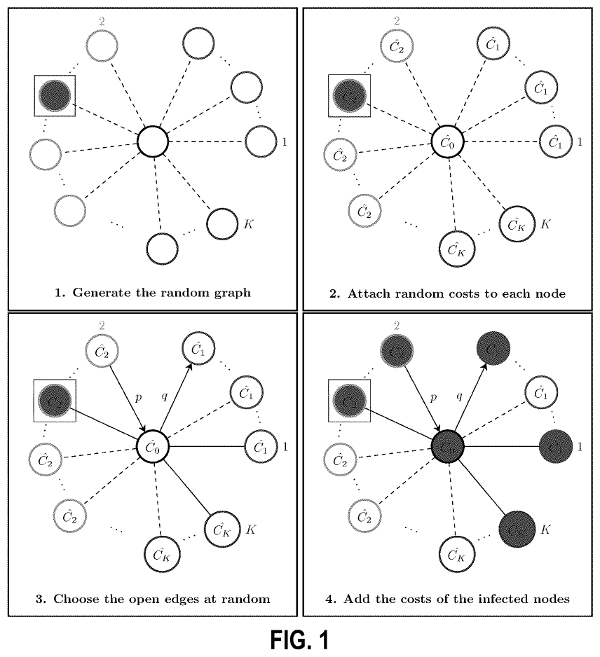

This section is devoted to the description of the stochastic framework we developed to study the distribution of aggregate loss. We introduce a continuous-time Markov chain loss process (Lₜ) that records the aggregate loss up to time t. For loss assessment, which is needed in insurance pricing, for example, the objective is to compute the mean and variance of Lₜ. The process is built from the combination of various components, including a Poisson process modeling the times at which cyberattacks occur, a random star graph whose central node represents the central server and the nodes as clients at the times of the attacks, a percolation process on this random star graph modeling the contagion, and a collection of cost distributions attached to each client-server node in the network (see FIG. 1).

As shown in Figure (FIG. 1, in each illustration, the node with the red frame denotes the peripheral (i.e., client) node as the origin of the contagion, whose loss distribution is being considered. First, we generate the random star. Second, we attach local random costs to each node. Third, we use independent coin flips to ascertain which edges are open, denoted as solid edges. In particular, the directed edge p describes the edge contagion probability from the peripheral node to the central node, while q describes the edge contagion probability from the central node to the peripheral node. The undirected edges are bidirectional, which are comprised of the two directed edges. Fourth, we add the costs of all the infected nodes, which are red, connected to the origin by a path of open edges.

More precisely, the process is constructed from the following components:
A Poisson process (Nₜ) with intensity λ.
A random star graph G with vertex set V and edge set E whose random number of branches is described by the discrete random variable X with

P(X=k)=pₖ for all k∈ [symbol] .
A random variable A with range {1, 2, . . . , K}, where K is the number of client types, indicating the different types of the clients on the random star graph, with probability mass function

P(Λ=l)=qₗ for all l=1,2, . . . ,K.
Two percolation parameters p, q∈(0,1).
The probability r∈(0,1) that the contagion starts at the central server.

Therefore, we define precisely a business's cybersecurity environment as the collection of the parameters p, q, and r. And so, the process evolves as follows. At the arrival times

Tⁱ=inf{t:Nₜ=i} for all i∈ [symbol] *
of the Poisson process, we let Gⁱ=(Vⁱ, Eⁱ) be a realization of the random star graph with Xⁱ edges, where Xⁱ is a realization of the random variable X. That is, we draw k edges starting from the center representing the central server with probability pₖ, which results in k clients. Time Tⁱ is the time of the ith contagion while Gⁱ represents the connections between the central server and the clients active at that time. Because the type of the client matters in determining the loss, we assume that client x is located in type Λₓⁱ, where Λₓⁱ is a realization of the random variable Λ. That is, x is located in type l independently with probability qₗ.

To quantify the financial loss, we attach a local cost Ĉₓⁱ to each vertex x∈Vⁱ representing the loss resulting from vertex x being infected, and whose distribution depends on the type of vertex x. More precisely, we assume that

$$P ( {\hat{C}}_{x}^{i} ∈ B \vert {Λ}_{c}^{i} = l ) = P ( \overline{{C}_{l}} ∈ B )$$

for every Borel set B⊂ [symbol] and every integer l>0, where the local costs Ĉₓⁱ are also assumed to be independent.

To model the contagion on the random star, we use an oriented bond percolation process with parameters p and q. That is, we let

$$\begin{matrix}{ξ}_{1}^{i} ( x ) = Bernoulli ( p ) \\ {ξ}_{2}^{i} ( x ) = Bernoulli ( q )\end{matrix} for all x ∈ {V}_{*}^{i} = {V}^{i} \backslash \{ 0 \}$$

be independent. Then, we draw
an arrow x→0 if and only if ξ₁ⁱ(x)=1
an arrow 0→x if and only if ξ₂ⁱ(x)=1
to indicate the direction in which the contagion can spread. We also assume that the contagion starts at the center of the star with probability r and from one of the clients chosen uniformly at random with probability 1−r. Letting [symbol] ⁱ be the origin of the contagion, the set of vertices that get infected is the percolation cluster starting from [symbol] ⁱ defined as
Cⁱ( [symbol] ⁱ)={x∈Vⁱ: there is a directed path of arrows [symbol] ⁱ→x}.
   For every subset of the vertex set A⊂Vⁱ, we let
Sⁱ(A)=number of vertices in A that are infected,
Cⁱ(A)=loss restricted to A resulting from the contagion.
   in equations, these two random variables can be written as

$${S}^{i} ( A ) = card ( {C}^{i} ( {𝒪}^{i} ) ⋂ A )$$

$$and$$

$${C}^{i} ( A ) = {\sum }_{x ∈ {C}^{i} ( {𝒪}^{i} ) ⋂ A} {\hat{C}}_{x}^{i} .$$

because the central server plays a special role, we let
Sⁱ=Sⁱ(Vⁱ)=total size, Cⁱ=Cⁱ(Vⁱ)=total loss,
S₀ⁱ=Sⁱ({0})=central size, C₀ⁱ=Cⁱ({0})=central loss,
S_{*}ⁱ=Sⁱ(V_{*}ⁱ)=peripheral size. C_{*}ⁱ=Cⁱ(V_{*}ⁱ)=peripheral loss.
to keep the notation short. The key quantity to be studied is the aggregate financial loss Lₜ caused by all the contagions that occur between time zero and time t, defined as

$${L}_{t} = {\sum }_{i = 1}^{{N}_{t}} {C}^{i} = {{\sum }_{i = 1}}^{{N}_{t}} {\sum }_{x ∈ {C}^{i} ( {𝒪}^{i} )} {\hat{C}}_{x}^{i} .$$

Thus, the main objective is to compute the expected value and variance of the aggregate loss Lₜ. We will see later that, because the successive contagions are independent and identically distributed, the mean and variance of the aggregate loss can be easily expressed using the mean and variance of the loss resulting from a single contagion.

### 4. Analytical Results

As previously mentioned, the main objective is to compute the mean and the variance of the aggregate loss. Because the consecutive contagions, and therefore the losses Cⁱ, are independent and identically distributed, conditioning on Nₜ, we get

$$E ( {L}_{t} \vert {N}_{t} ) = E ( {\sum }_{i = 1}^{{N}_{t}} {C}^{i} \vert {N}_{t} ) = {N}_{t} E ( {C}^{1} )$$

$$Var ( {L}_{t} \vert {N}_{t} ) = Var ( {\sum }_{i = 1}^{{N}_{t}} {C}^{i} \vert {N}_{t} ) = {N}_{t} Var ( {C}^{1} ) .$$

Using that the number of contagions Nₜ is Poisson with mean λt, taking the expected value in the fist equation to get the mean of the aggregate loss, and using both equations together with the law of total variance to get the variance of the aggregate loss give

$$E ( {L}_{t} ) = E ( {N}_{t} E ( {C}^{1} ) ) = E ( {N}_{t} ) E ( {C}^{1} ) = λ tE ( {C}^{1} ) \qquad ( 1 )$$

$$Var ( {L}_{t} ) = E ( Var ( {L}_{t} \vert {N}_{t} ) ) + Var ( E ( {L}_{t} \vert {N}_{t} ) ) = E ( {N}_{t} ) Var ( {C}^{1} ) + Var ( {N}_{t} ) {( E ( {C}^{1} ) )}^{2} = λ t ( Var ( {C}^{1} ) + {( E ( {C}^{1} ) )}^{2} ) .$$

Motivated by (1), we now drop all the superscripts i referring to the number of the contagion, and focus on the mean and variance of the loss resulting from a single contagion. Our main results give explicit expressions of these quantities as a function of the model's parameters, namely, the probabilities p, q, r and qₖ, the mean and variance of the number of edges, and the loss distribution for each case study. To this end, we need to find the mean and variance of the local costs. These quantities are easy to express (using the probabilities qₖ and the loss distribution in each client type) because the local costs do not depend on the realization of the percolation process or the structure of the network. Indeed, by conditioning on the random variable Λₓ, we get

$$E ( {( {\hat{C}}_{x} )}^{n} ) = {\sum }_{l = 1}^{K} E ( {( {\hat{C}}_{x} )}^{n} \vert {Λ}_{x} = l ) P ( {Λ}_{x} = l ) = {\sum }_{l = 1}^{K} {q}_{l} E ( {( \overline{{C}_{l}} )}^{n} )$$

for all integers n>0. In particular, for all x∈V_{*},

$$E ( {\hat{C}}_{x} ) {\sum }_{l = 1}^{K} {q}_{l} E ( \overline{{C}_{l}} ) \qquad ( 2 ) .$$

$$and$$

$$Var ( {\hat{C}}_{x} ) = {\sum }_{l = 1}^{K} {q}_{l} E ( {( \overline{{C}_{l}} )}^{2} ) - {( {\sum }_{l = 1}^{K} {q}_{l} E ( \overline{{C}_{l}} ) )}^{2} .$$

The mean and variance of the total loss resulting from a single contagion can also be easily expressed by using (2) and the mean and variance of the size of the contagion. The size of the contagion, however, is more difficult to study because the events that different vertices are infected are correlated, and depend on the structure of the network. The size of the contagion depends on the probabilities p, q, r and the random number of edges. Also, to state our main results, we let

$$μ = E ( X ) = {\sum }_{k = 0}^{∞} {kp}_{k}$$

$$and$$

$${σ}^{2} = Var ( X ) {\sum }_{k = 0}^{∞} {( k - μ )}^{2} {p}_{k} .$$

To begin with, we look at the mean of the total loss resulting from a single contagion. The key to computing the mean is to use the linearity of the expectation and that a vertex y is infected if and only if there is a directed path of arrows from the origin of the contagion to vertex y.

Theorem 1 (mean of the loss).—The mean of the loss is

$$E ( C ) = E ( {S}_{0} ) E ( {\hat{C}}_{0} ) + E ( {S}_{*} ) E ( {\hat{C}}_{1} )$$

where E(S₀) and E(S_{*)} are given by

$$E ( {S}_{0} ) = r + ( 1 - r ) p \qquad ( 3 )$$

$$and$$

$$E ( {S}_{*} ) = rq μ + ( 1 - r ) ( 1 + pq ( μ - 1 ) )$$

and where E(Ĉ₁) is given in (2).

The variance of the total cost is more difficult to obtain because it requires computing the probability that any two given vertices, say y and z, are infected while the events that two vertices are infected are not independent in general. This is due to the fact that directed paths of arrows from the origin of the contagion to y and z may overlap.

Theorem 2 (variance of the loss).—The variance of the loss is

$$Var ( C ) = E ( {S}_{0} ) Var ( {\hat{C}}_{0} ) + Var ( {S}_{0} ) {( E ( {\hat{C}}_{0} ) )}^{2} + E ( {S}_{*} ) Var ( {\hat{C}}_{1} ) + Var ( {S}_{*} ) {( E ( {\hat{C}}_{1} ) )}^{2} - 2 ( 1 - E ( {S}_{0} ) ) ( 1 - E ( {S}_{*} ) ) E ( {\hat{C}}_{0} ) E ( {\hat{C}}_{1} )$$

where Var(S₀) and Var(S_{*}) are given by

$$Var ( {S}_{0} ) = ( 1 - r ) ( 1 - p ) ( r + ( 1 = r ) p )$$

$$Var ( {S}_{*} ) = rq ( q {σ}^{2} + ( 1 - q ) μ ) + pq ( 1 - r ) ( q {σ}^{2} + ( μ - 1 ) ( 1 + q ( μ - 2 ) - pq ( μ - 1 ) ) ) + r ( 1 - r ) {( 1 + pq ( μ - 1 ) - q μ )}^{2}$$

and where E(Ĉ₁), Var(Ĉ₁), E(S₀) and E(S_{*}) are given in (2) and (3).

Assuming that hackers focus on the central server of the network where most of the information is stored, we have r=1, in which case the mean and variance of the cost reduces to

$$E ( C ) = E ( {\hat{C}}_{0} ) + q μ E ( {\hat{C}}_{1} )$$

$$Var ( C ) = Var ( {\hat{C}}_{0} ) + q μ Var ( {\hat{C}}_{1} ) + q ( q {σ}^{2} + ( 1 - q ) μ ) {( E ( {\hat{C}}_{1} ) )}^{2} .$$

Assuming on the contrary that hackers make their way through the network attacking one of the many clients, we have r=0 and the mean and variance of the cost become

$$E ( C ) = pE ( {\hat{C}}_{0} ) + ( 1 + pq ( μ - 1 ) ) E ( {\hat{C}}_{1} )$$

$$Var ( C ) = p Var ( {\hat{C}}_{0} ) + p ( 1 - p ) {( E {\hat{C}}_{0} )}^{2} + ( 1 + pq ( μ - 1 ) ) Var ( {\hat{C}}_{1} ) + pq ( q {σ}^{2} + ( μ - 1 ) ( 1 + q ( μ - 2 ) - pq ( μ - 1 ) ) ) {( E ( {\hat{C}}_{1} ) )}^{2} + 2 pq ( 1 - p ) ( μ - 1 ) E ( {\hat{C}}_{0} ) E ( {\hat{C}}_{1} ) .$$

We first study the conditional mean and variance of the peripheral size given that the contagion starts at the central server, then given that the contagion starts from a client. These are combined to compute the mean and variance of the peripheral size when the contagion starts from the central server with probability r. This is finally used to compute the mean and the variance of the loss resulting from a single contagion.

### 4.1. Peripheral Size of Contagion from the Central Server

In this section, we compute the mean and variance of the peripheral size S_{*} (the number of clients being infected) of a contagion starting from the central server of the star with a random number X of branches. Defining the function ζ: V→{0,1} as

ζ(y)=1{vertex y is infected} for all y∈V,

we will use repeatedly that the peripheral size can be expressed as

$${S}_{*} = card \{ y ∈ {V}_{*} : y is infected \} = ζ ( 1 ) + ζ ( 2 ) + … + ζ ( X ) . \qquad ( 4 )$$

Throughout this section, the subscript 0 is to emphasize that the mean and variance are for a contagion starting at the central server of the star, not a client.

Lemma 1.—The mean of the peripheral size is E₀(S_{*})=qμ.

Proof. Given that the contagion starts at the central server, the probability that client y is being infected is simply the probability q that there is an arrow 0→y. In particular, taking the conditional expectation on both sides of equation (4), we get

$${E}_{0} ( {S}_{*} \vert X ) = {E}_{0} ( ζ ( 1 ) + … + ζ ( X ) \vert X ) = {XE}_{0} ( ζ ( 1 ) ) = qX . \qquad ( 5 )$$

Then, taking the expectation on both sides, we conclude that

$${E}_{0} ( {S}_{*} ) = E ( {E}_{0} ( {S}_{*} \vert X ) ) = E ( qX ) = qE ( X ) - q μ .$$

This completes the proof. □

Lemma 2.—The variance of the peripheral size is

$${Var}_{0} ( {S}_{*} ) = q ( q {σ}^{2} + ( 1 - q ) μ ) .$$

Proof. Observing that the random variables ζ(y) for y≠0 are independent when the contagion starts from the central server, and Bernoulli distributed with success probability q, we get

$${Var}_{0} ( {S}_{*} \vert X ) = {Var}_{0} ( ζ ( 1 ) + … + ζ ( X ) \vert X ) = X {Var}_{0} ( ζ ( 1 ) ) = q ( 1 - q ) X .$$

Then, using the law of total variance and (5) gives

$$\begin{matrix}{Var}_{0} ( {S}_{*} ) = E ( {Var}_{0} ( {S}_{*} \vert X ) ) + Var ( {E}_{0} ( {S}_{*} \vert X ) ) \\ = E ( q ( 1 - q ) X ) + Var ( qX ) = q ( 1 - q ) E ( X ) + {q}^{2} Var ( X ) \\ = q ( q {σ}^{2} + ( 1 - q ) μ ) .\end{matrix}$$

This completes the proof. □

### 4.2. Peripheral Size of Contagion from a Client

The objective of this section is to compute the mean and variance of the peripheral size of a contagion starting from a client x. Due to spherical symmetry, the choice of x is unimportant. The strategy is the same as in the previous section: we first compute the conditional mean and variance given the number of branches, then deduce their unconditional counterparts. The proof, however, is more complicated due to a lack of independence when the contagion starts from a client. As previously, the subscript x is to emphasize that the contagion starts from x.

Lemma 3.—For all x∈V_{*}, the mean of the peripheral size is

$${E}_{x} ( {S}_{*} ) = 1 + pq ( μ - 1 ) .$$

Proof. When the contagion starts at client x, the probability that a client y≠x is being infected is equal to the probability pq that there is an arrow x→0 and an arrow 0→y. In particular, taking the conditional expectation on both sides of equation (4) gives

$$( 6 )$$

$$\begin{matrix}{E}_{x} ( {S}_{*} \vert X ) = {E}_{x} ( ζ ( 1 ) + … + ζ ( X ) \vert X ) \\ = {E}_{x} ( ζ ( x ) ) + {E}_{x} ( ζ ( 1 ) + … + ζ ( x - 1 ) + ζ ( x + 1 ) + … + ζ ( X ) \vert X ) \\ = {E}_{x} ( ζ ( x ) ) + ( X - 1 ) {E}_{x} ( ζ ( 1 ) ) = 1 pq ( X - 1 )\end{matrix}$$

where we used that Pₓ(ζ(x)=1)=1. Then, taking the expected value,

$${E}_{x} ( {S}_{*} ) = E ( {E}_{x} ( {S}_{*} \vert X ) ) = E ( 1 + pq ( X - 1 ) ) = 1 + pq ( μ - 1 ) ,$$

which proves the result. □

Lemma 4.—For all x∈V, the variance of the peripheral size is

$${Var}_{x} ( {S}_{*} ) = pq ( q {σ}^{2} + ( μ - 1 ) ( 1 + q ( μ - 2 ) - pq ( μ - 1 ) ) ) .$$

Proof. The proof is more difficult than the proof of Lemma 2 because the ξ(y) for y≠0 is not independent when the contagion starts from client x. This is due to the fact that paths from x to two other clients overlap. Using (4) and (6), we get

$$( 7 )$$

$${Var}_{x} ( {S}_{*} \vert X ) = {E}_{x} ( {( ζ ( 1 ) + … + ζ ( X ) )}^{2} \vert X ) - {( {E}_{x} ( ζ ( 1 ) + … + ζ ( X ) \vert X ) )}^{2} = {E}_{x} ( {( ζ ( 1 ) + … + ζ ( X ) )}^{2} \vert X ) - 1 + {pq ( X - 1 )}^{2} .$$

To compute the second moment, we observe that

Eₓ(ζ(y)ζ(z))=Pₓ(ζ(y)=ζ(z)=1) for y,z∈V.
is the probability that there is a path of arrows x→y and a path of arrows x→z. In particular, distinguishing among the different choices of clients y and z,

$${E}_{x} ( ζ ( y ) ζ ( z ) ) = \{ \begin{matrix}1 & when & card \{ x , y , z \} = 1 \\ pq & when & card \{ x , y , z \} = 2 \\ {pq}^{2} & when & card \{ x , y , z \} = 3\end{matrix} .$$

Counting the number of vertices, we deduce that

$${E}_{x} ( {( ζ ( 1 ) + … + ζ ( X ) )}^{2} \vert X ) = 1 + 3 ( X - 1 ) pq + ( X - 1 ) ( X - 2 ) {pq}^{2} , \qquad ( 8 )$$

then, combining (7) and (8),

$$\begin{matrix}{Var}_{x} ( {S}_{*} \vert X ) = 1 + 3 pq ( X - 1 ) + {pq}^{2} ( X - 1 ) ( X - 2 ) - {( 1 + pq ( X - 1 ) )}^{2} \\ pq ( X - 1 ) + {pq}^{2} ( X - 1 ) ( X - 2 ) - {p}^{2} {{q}^{2} ( X - 1 )}^{2} \\ pq ( X - 1 ) ( 1 + q ( X - 2 ) - pq ( X - 1 ) ) .\end{matrix} \qquad ( 9 )$$

Using the law of total variance, then (7) and (9), gives

$${Var}_{x} ( {S}_{*} ) = E ( {Var}_{x} ( {S}_{*} \vert X ) ) + Var ( {E}_{x} ( {S}_{*} \vert X ) ) = E ( pq ( X - 1 ) ( 1 + q ( X - 2 ) - pq ( X - 1 ) ) ) + Var ( 1 + pq ( X - 1 ) ) . \qquad ( 10 )$$

The last term in (10) reduces to (12)

$$Var ( 1 + pq ( X - 1 ) ) = Var ( pqX ) = {( pq )}^{2} Var ( X ) = {( pq )}^{2} {σ}^{2} . \qquad ( 11 )$$

In addition, using that E(X²)=Var(X)+E(X)²=σ²+μ² gives

$$E ( {Var}_{x} ( {S}_{*} \vert X ) ) = pq E ( ( X - 1 ) ( 1 + q ( X - 2 ) - p q ( X - 1 ) ) ) = pq ( ( E ( X ) - 1 ) ( 1 + q ( E ( X ) - 2 ) - p q ( E ( X ) - 1 ) ) + q ( 1 - p ) Var ( X ) ) = pq ( q ( 1 - p ) {σ}^{2} + ( μ - 1 ) ( 1 + q ( μ - 2 ) - p q ( μ - 1 ) ) ) . \qquad ( 12 )$$

Combining (10)-(12), we conclude that

$$\begin{matrix}Va {r}_{x} ( {S}_{*} ) = pq ( q ( 1 - p ) {σ}^{2} + ( μ - 1 ) ( 1 + q ( μ - 2 ) - p q ( μ - 1 ) ) ) = {( p q )}^{2} {σ}^{2} \\ = pq ( q {σ}^{2} + ( μ - 1 ) ( 1 + q ( μ - 2 ) - p q ( μ - 1 ) ) ) .\end{matrix}$$

This completes the proof. □

### 4.3. Peripheral Size of Contagion from a Random Vertex

Combining the results from the previous two sections, we now compute the mean and the variance of the peripheral size of a contagion starting from the central server with probability r and from one of the clients chosen uniformly at random with probability 1−r, i.e.,

$$P ( 𝒪 = 0 ) = r and P ( 𝒪 \neq 0 ) = 1 - r \qquad ( 13 )$$

where [symbol] is the origin of the contagion.

Lemma 5.—The mean of the peripheral size is

$$E ( {S}_{*} ) = rq μ + ( 1 - r ) ( 1 + p q ( μ - 1 ) ) .$$

Proof. It follows from Lemmas 1 and 3 that

$$\begin{matrix}E ( {S}_{*} \vert 𝒪 ) = {E}_{0} ( {S}_{*} ) 1 \{ 𝒪 = 0 \} + {E}_{x} ( {S}_{*} ) 1 ( 𝒪 \neq 0 ) \\ = q μ 1 \{ 𝒪 = 0 \} + ( 1 + p q ( μ - 1 ) ) 1 \{ 𝒪 \neq 0 \} .\end{matrix} \qquad ( 14 )$$

Taking the expected value and using (13), we deduce that

$$\begin{matrix}E ( {S}_{*} ) = E ( E ( {S}_{*} \vert 𝒪 ) ) = q μ E ( 1 \{ 0 = 0 \} ) + ( 1 + p q ( μ - 1 ) ) E ( 1 \{ 𝒪 \neq 0 \} ) \\ = rq μ + ( 1 - r ) ( 1 + p q ( μ - 1 ) ) .\end{matrix}$$

This completes the proof. □

Before computing the variance, we prove the following technical result.

Lemma 6.—For the random variable [symbol] defined in (13),

$$Var ( 1 \{ 𝒪 = 0 \} ) = Var ( 1 \{ 𝒪 \neq 0 \} ) = + r ( 1 - r )$$

$$cov ( 1 \{ 𝒪 = 0 \} , 1 \{ 𝒪 \neq 0 \} ) = - r ( 1 - r ) .$$

Proof. For any two events A and B, we have

$$cov ( {1}_{A} , {1}_{B} ) = E ( ( {1}_{A} - P ( A ) ) ( {1}_{B} - P ( B ) ) ) = P ( A ∩ B ) - P ( A ) P ( B ) .$$

In particular, for the two events under consideration,

$$\begin{matrix}cov ( 1 \{ 𝒪 = 0 \} , 1 \{ 𝒪 = 0 \} ) = P ( 𝒪 = 0 ) ( 1 - P ( 𝒪 = 0 ) ) = r ( 1 - r ) , \\ cov ( 1 \{ 𝒪 \neq 0 \} , 1 \{ 𝒪 \neq 0 \} ) = P ( 𝒪 \neq 0 ) ( 1 - P ( 𝒪 \neq 0 ) ) = ( 1 - r ) \\ = ( 1 - r ) ( 1 - ( 1 - r ) ) = r ( 1 - r ) , \\ cov ( 1 \{ 𝒪 = 0 \} , 1 \{ 𝒪 \neq 0 \} ) = P ( ∅ ) - P ( 𝒪 = 0 ) P ( 𝒪 \neq 0 ) = r ( 1 - r ) ,\end{matrix}$$

which completes the proof. □
Lemma 7.—The variance of the peripheral size is

$$Var ( {S}_{*} ) = r q ( q {σ}^{2} + ( 1 - q ) μ ) + p q ( 1 - r ) ( q {σ}^{2} + ( μ - 1 ) ( 1 + q ( μ - 2 ) - p q ( μ - 1 ) ) ) + r ( 1 - r ) {( 1 + p q ( μ - 1 ) - q μ )}^{2} .$$

Proof. As previously, the starting point is to use the law of total variance

$$Var ( {S}_{*} ) = E ( Var ( {S}_{*} \vert 𝒪 ) ) + Var ( E ( {S}_{*} \vert 𝒪 ) ) . \qquad ( 15 )$$

It follows from Lemmas 2 and 4 that

$$\begin{matrix}Var ( {S}_{*} \vert 𝒪 ) = {Var}_{0} ( {S}_{*} ) 1 \{ 𝒪 = 0 \} + {Var}_{x} ( {S}_{*} ) 1 \{ 𝒪 \neq 0 \} \\ = \begin{matrix}q ( q {σ}^{2} + ( 1 - q ) μ ) 1 \{ 𝒪 = 0 \} + \\ pq ( q {σ}^{2} + ( μ - 1 ) ( 1 + q ( μ - 2 ) - p q ( μ - 1 ) ) ) 1 \{ 𝒪 \neq 0 \}\end{matrix}\end{matrix}$$

which, together with (13), implies that

$$E ( Var ( {S}_{*} \vert 𝒪 ) ) = r q ( q {σ}^{2} + ( 1 - q ) μ ) + pq ( 1 - r ) ( q {σ}^{2} + ( μ - 1 ) ( 1 + q ( μ - 2 ) - p q ( μ - 1 ) ) ) . \qquad ( 16 )$$

In other respects, using (14) and Lemma 6, we get

$$\begin{matrix}Var ( E ( {S}_{*} \vert 𝒪 ) ) = Var ( {E}_{0} ( {S}_{*} ) 1 \{ 𝒪 = 0 \} + {E}_{x} ( {S}_{*} ) 1 ( 𝒪 \neq 0 ) ) \\ = {( {E}_{0} ( {S}_{*} ) )}^{2} Var ( 1 \{ 𝒪 = 0 \} ) + {( {E}_{x} ( {S}_{*} ) )}^{2} Var ( 1 \{ 𝒪 \neq 0 \} ) + \\ 2 {E}_{0} ( {S}_{*} ) {E}_{x} ( {S}_{*} ) cov ( 1 \{ 𝒪 = 0 \} , 1 \{ 𝒪 \neq 0 \} ) \\ = r ( 1 - r ) {( {E}_{0} ( {S}_{*} ) )}^{2} + r ( 1 - r ) {( {E}_{x} ( {S}_{*} ) )}^{2} - \\ 2 r ( 1 - r ) {E}_{0} ( {S}_{*} ) {E}_{x} ( {S}_{*} ) \\ = r ( 1 - r ) {( {E}_{0} ( {S}_{*} ) - {E}_{x} ( {S}_{*} ) )}^{2} ,\end{matrix}$$

then applying Lemmas 1 and 3, we obtain

$$Var ( E ( {S}_{*} \vert 𝒪 ) ) = r ( 1 - r ) {( 1 + pq ( μ - 1 ) - q μ )}^{2} . \qquad ( 17 )$$

Finally, combining (15)-(17), we conclude that

$$Var ( {S}_{*} ) = rq ( q {σ}^{2} + ( 1 - q ) μ ) + p q ( 1 - r ) ( q {σ}^{2} + ( μ - 1 ) ( 1 + q ( μ - 2 ) - p q ( μ - 1 ) ) ) + r ( 1 - r ) {( 1 + p q ( μ - 1 ) - q μ )}^{2} .$$

This completes the proof. □

### 4.4. Proof of Theorems 1 and 2

Lemmas 5 and 7 give explicit expressions of the mean and variance of the peripheral size of a single contagion. In this section, we express the mean and variance of the total loss as functions of these two quantities. Using the function ζ, the total loss can be written as

$$C = {C}_{0} + {C}_{*} where {C}_{0} = ζ ( 0 ) {\hat{C}}_{0} and {C}_{*} = {\sum }_{y = 1}^{x} ζ ( y ) {\hat{C}}_{y} .$$

To begin with, we compute the mean and variance of the peripheral loss and the mean and variance of the central loss, from which the mean and variance of the total loss will be deduced.

### The Peripheral Loss

We first study the peripheral loss C_{*} localized on the clients. More precisely, we compute the mean and variance of C_{*}, which can be done by conditioning on the peripheral size S_{*}.

Lemma 8.—The peripheral loss C_{*} satisfies

$$E ( {C}_{*} ) = E ( {S}_{*} ) E ( {\hat{C}}_{1} ) and Var ( {C}_{*} ) = E ( {S}_{*} ) Var ( {\hat{C}}_{1} ) + Var ( {S}_{*} ) {( E ( {\hat{C}}_{1} ) )}^{2} .$$

Proof. By independence of the local costs,

$$\begin{matrix}E ( {C}_{*} \vert {S}_{*} = s ) = E ( {\hat{C}}_{1} + … + {\hat{C}}_{s} ) = s E ( {\hat{C}}_{1} ) \\ Var ( {C}_{*} \vert {S}_{*} = s ) = Var ( {\hat{C}}_{1} + … + {\hat{C}}_{s} ) = s Var ( {\hat{C}}_{1} )\end{matrix} . \qquad ( 18 )$$

The first line in (18) implies that

$$E ( {C}_{*} ) = E ( E ( {C}_{*} \vert {S}_{*} ) ) = E ( {S}_{*} E ( {\hat{C}}_{1} ) ) = E ( {S}_{*} ) E ( {\hat{C}}_{1} ) ,$$

while using also the second line in (18) and the law of total variance gives

$$\begin{matrix}Var ( {C}_{*} ) = E ( Var ( {C}_{*} \vert {S}_{*} ) ) + Var ( E ( {C}_{*} \vert {S}_{*} ) ) \\ = E ( {S}_{*} Var ( {\hat{C}}_{1} ) ) + Var ( {S}_{*} E ( {\hat{C}}_{1} ) ) = E ( {S}_{*} ) Var ( {\hat{C}}_{1} ) + Var ( {S}_{*} ) {( E ( {\hat{C}}_{1} ) )}^{2}\end{matrix} .$$

This completes the proof. □

### The Central Loss

We now study the partial loss C₀ localized on the central server. The first step is to compute the mean and the variance of the central size whose role is analogous to the peripheral size above. In all the lemmas below, we repeatedly use that S₀ is equal to zero or one depending on whether the central server of the star is not infected or is infected. In other words, we have S₀=ζ(0).

Lemma 9.—The mean of the central size is E(S₀)=r+(1−r)p.

Proof. Using that, for each client x∈V_{*},

$$\begin{matrix}{E}_{0} ( {S}_{0} ) = {P}_{0} ( ζ ( 0 ) = 1 ) = 1 \\ {E}_{x} ( {S}_{0} ) = {P}_{x} ( ζ ( 0 ) = 1 ) = P ( there is an arrow x \to 0 ) = p\end{matrix} \qquad ( 19 )$$

and conditioning on whether [symbol] =0 or not, we deduce that

$$\begin{matrix}E ( {S}_{0} ) = E ( {S}_{0} \vert 𝒪 = 0 ) P ( 𝒪 = 0 ) + E ( {S}_{0} \vert 𝒪 \neq 0 ) P ( 𝒪 \neq 0 ) \\ = {rE}_{0} ( {S}_{0} ) + ( 1 - r ) {E}_{x} ( {S}_{0} ) = r + ( 1 - r ) p\end{matrix} .$$

This completes the proof. □

Lemma 10.—The variance of the central size is

$$Var ( {S}_{0} ) = ( 1 - r ) ( 1 - p ) ( r + ( 1 - r ) p ) .$$

Proof. Observing that S₀=ζ(0) is equal to one on the event that [symbol] =0 whereas it is Bernoulli with success probability p on the event that [symbol] ≠0, we get

$$\begin{matrix}Var ( {S}_{0} \vert 𝒪 ) = Var ( 1 ) 1 \{ 𝒪 = 0 \} + Var ( Bernoulli ( p ) ) 1 \{ 𝒪 \neq 0 \} \\ = p ( 1 - p ) 1 \{ 𝒪 \neq 0 \}\end{matrix} . \qquad ( 20 )$$

Using (19) and Lemma 6, we also have

$$\begin{matrix}Var ( E ( {S}_{0} \vert 𝒪 ) ) = Var ( 1 ) \{ 𝒪 = 0 \} + p 1 \{ 𝒪 \neq 0 \} \\ = Var ( 1 \{ 𝒪 = 0 \} ) + 2 p cov ( 1 \{ 𝒪 = 0 \} , 1 \{ 𝒪 \neq 0 \} ) + {p}^{2} Var ( 1 \{ 𝒪 \neq 0 \} ) \\ = r ( 1 - r ) ( 1 - 2 p + {p}^{2} ) + r ( 1 - r ) {( 1 - p )}^{2}\end{matrix} . \qquad ( 21 )$$

Combining (20) and (21), and the law of total variance, we conclude that

$$V a r ( {S}_{0} ) = E ( Var ( {S}_{0} \vert 𝒪 ) ) + V a r ( E ( {S}_{0} \vert 𝒪 ) )$$

$$= p ( 1 - p ) P ( 𝒪 \neq 0 ) + r ( 1 - r ) {( 1 - p )}^{2} = ( 1 - r ) ( 1 - p ) ( p + r ( 1 - p ) )$$

$$= ( 1 - r ) ( 1 - p ) ( r + ( 1 - r ) p ) .$$

This completes the proof. □

The mean and variance of C₀ can be expressed using the mean and variance of S₀.

Lemma 11.—The mean and variance of C₀ are

$$E ( {C}_{0} ) = E ( {S}_{0} ) E ( {\hat{C}}_{0} ) and Var ( {C}_{0} ) = E ( {S}_{0} ) Var ( {\hat{C}}_{0} ) + Var ( {S}_{0} ) {( E ( {\hat{C}}_{0} ) )}^{2} .$$

Proof. This follows the proof of Lemma 8, observing that

$$E ( {C}_{0} \vert {S}_{0} ) = {S}_{0} E ( {\hat{C}}_{0} ) and Var ( {C}_{0} \vert {S}_{0} ) = {S}_{0} Var ( {\hat{C}}_{0} ) ,$$

and replacing S_{*} by S₀=ζ(0), and Ĉ₁ by Ĉ₀. □

### The Total Loss

Finally, we study the total loss C=C₀+C_{*}. The mean given in Theorem 1 can be easily deduced from the previous results using also the linearity of the expected value. The variance, however, is more difficult to compute because the random variables C₀ and C_{*} are not independent.

PROOF OF THEOREM 1. Using Lemmas 8 and 11, we get

$$E ( C ) = E ( {S}_{0} ) E ( {\hat{C}}_{0} ) + E ( {S}_{*} ) E ( {\hat{C}}_{1} ) .$$

In addition, Lemmas 5 and 9 give respectively

$$E ( {S}_{*} ) = rq μ + ( 1 - r ) ( 1 + pq ( μ - 1 ) ) and E ( {S}_{0} ) = r + ( 1 - r ) p .$$

This completes the proof. □

To find the variance, we first compute the covariance of C₀ and C_{*}.

Lemma 12.—The covariance is given by

$$cov ( {C}_{0} , {C}_{*} ) = - ( 1 - E ( {S}_{0} ) ) ( 1 - E ( {S}_{*} ) ) E ( {\hat{C}}_{0} ) E ( {\hat{C}}_{1} ) .$$

Proof. For each client y∈V_{*},

$$E ( ζ ( 0 ) ζ ( y ) \vert 𝒪 = x ) = P ( ζ ( 0 ) = ζ ( y ) = 1 \vert 𝒪 = x ) = \{ \begin{matrix}q & when & x = 0 \\ p & when & x = y \\ pq & when & x \neq 0 , y\end{matrix}$$

from which it follows that

$$E ( ζ ( 0 ) ζ ( y ) \vert X = d ) = rq + ( \frac{1 - r}{d} ) p + ( 1 - r ) ( 1 - \frac{1}{d} ) pq .$$

Using also that the local costs are independent, we get

$$\begin{matrix}E ( {C}_{0} {C}_{*} \vert X = d ) = d E ( ζ ( 0 ) {\hat{C}}_{0} ζ ( 1 ) {\hat{C}}_{1} \vert X = d \\ = d E ( ζ ( 0 ) ζ ( 1 ) \vert X = d ) E ( {\hat{C}}_{0} ) E ( {\hat{C}}_{1} ) \\ = ( rqd + ( 1 - r ) p ( 1 + q ( d - 1 ) ) ) E ( {\hat{C}}_{0} ) E ( {\hat{C}}_{1} ) .\end{matrix}$$

This, together with Lemmas 8 and 11, implies that

$$\begin{matrix}cov ( {C}_{0} , {C}_{*} ) = E ( {C}_{0} {C}_{*} ) - E ( {C}_{0} ) E ( {C}_{*} ) \\ = E ( E ( {C}_{0} {C}_{*} \vert X ) ) - E ( {C}_{0} ( E ( {C}_{*} ) \\ = ( rq μ + ( 1 - r ) ( p + pq ( μ - 1 ) ) - E ( {S}_{0} ) E ( {S}_{*} ) ) E ( {\hat{C}}_{0} ) E ( {\hat{C}}_{1} ) .\end{matrix} \qquad ( 22 )$$

Using Lemmas 5 and 9, we also have

$$\begin{matrix}rq μ + ( 1 - r ) ( p + pq ( μ - 1 ) ) = rq μ + ( 1 - r ) ( 1 + pq ( μ - 1 ) ) - ( 1 - r ) ( 1 - p ) \\ = rq μ + ( 1 - r ) ( 1 + pq ( μ - 1 ) ) + r ( + ( 1 - r ) p ) - 1 \\ = E ( {S}_{*} ) - E ( {S}_{0} ) - 1.\end{matrix} \qquad ( 23 )$$

Combining (22) and (23), we conclude that

$$\begin{matrix}= cov ( {C}_{0} , {C}_{*} ) = - ( 1 - E ( {S}_{0} ) - E ( {S}_{*} ) + E ( {S}_{0} ) E ( {S}_{*} ) ) E ( {\hat{C}}_{0} ) E ( {\hat{C}}_{1} ) \\ = - ( 1 - E ( {S}_{0} ) ) ( 1 - E ( {S}_{*} ) ) E ( {\hat{C}}_{0} ) E ( {\hat{C}}_{1} ) .\end{matrix}$$

This completes the proof. □

Note that E(S₀)=P(S₀=1)<1 and E(S_{*})>1 whenever p, q, r∈(0,1). This and the previous lemma imply that the partial losses C₀ and C_{*} are positively correlated.

PROOF OF THEOREM 2. Using Lemmas 8, 11 and 12, we get

$$\begin{matrix}Var ( C ) = Var ( {C}_{0} + {C}_{*} ) = Var ( {C}_{0} ) + Var ( {C}_{*} ) + 2 cov ( {C}_{0} , {C}_{*} ) \\ = E ( {S}_{0} ) Var ( {\hat{C}}_{0} ) + Var ( {S}_{0} ) {( E ( {\hat{C}}_{0} ) )}^{2} + \\ E ( {S}_{*} ) Var ( {\hat{C}}_{1} ) + Vqar ( {S}_{*} ) {( E ( {\hat{C}}_{1} ) )}^{2} - \\ 2 ( 1 - E ( {S}_{0} ) ) ( 1 - E ( {S}_{*} ) ) E ( {\hat{C}}_{0} ) E ( {\hat{C}}_{1} ) .\end{matrix}$$

In addition, Lemmas 7 and 10 give respectively

$$Var ( {S}_{*} ) = rq ( q {σ}^{2} + ( 1 - q ) μ ) + pq ( 1 - r ) ( q {σ}^{2} + ( μ - 1 ) ( 1 + q ( μ - 2 ) - pq ( μ - 1 ) ) ) + r ( 1 - r ) {( 1 + pq ( μ - 1 ) - q μ )}^{2} \\ Var ( {S}_{0} ) = ( 1 - r ) ( 1 - p ) ( r + ( 1 - r ) p ) .$$

This completes the proof. □

We now illustrate the usefulness of these theorems to cyber risk in client-server network architectures across various industries and businesses.

### 5. Case Studies

In this section, we provide four different case studies. The first Subsection 5.1 models the cyber risk of cardiological implantable electronic devices for a healthcare setting, the second Subsection 5.2 pertains to smart-building operators, the third Subsection 5.3 focuses on ride-sharing services, and finally, Subsection 5.4 addresses vehicle-to-vehicle cooperation. In each case study, we define random variables C̅₀̅, C̅₁̅, . . . , C̅_̅{̅K̅}̅, with C̅₀̅ to describe the loss resulting from the central server being infected, and the other random variables describing the loss resulting from infection in each of the K clients. Using these random variables, we characterize the exact expectation E(Lₜ) and the standard deviation \sqrt{Var(Lₜ)} of the losses of cyber risk. Lastly, we parametrize the cyber risk model by following the academic literature (see e.g. Jevtic′ and Lanchier (2020); Chiaradonna and Lanchier (2022); Chiaradonna et al. (2023)). In particular, without loss of generality, the frequency of the cyberattacks is λ=1 and the unit of time is t=1. Thus, the attacks occur at a rate of one per unit of time. Furthermore, we assume the attacks are equally likely to start from any node of the network. In addition, we model the costs C̅₀̅, C̅₁̅, . . . , C̅_̅{̅K̅}̅ to follow a log-normal distribution. We leverage the log-normal distribution due to its ability to capture heavy-tailed phenomena losses and its support of the positive real line, making it suitable for loss distribution characterization for cyber risk (see e.g. Shevchenko et al. (2023)).

### 5.1. Modeling Cyber Risk in Cardiological Implantable Electronic Devices

Heart diseases cause thousands of premature deaths and substantial economic losses in the U.S. Specialized cardiological implantable electronic devices (CIEDs), such as pacemakers, manage these diseases, yet they are susceptible to cyber risks that could lead to patient fatalities (Ngamboé et al., 2020). Hospitals, responsible for monitoring CIEDs via IT networks, face similar vulnerabilities, risking patient data loss (IBM Security, 2020). Therefore, hospital risk teams and decision-makers require unique liability assessment frameworks to tackle these cyber risks.

Technology. For continuous monitoring, the CIED sends heart-related data and the status of the battery's life wirelessly via a remote monitor to a centralized repository in the hospital's IT network (Lappegaård and Moe, 2022). And, during routine checkups at the hospital, the patient's physician wirelessly via an external computer connected to the hospital's centralized repository updates the CIED with new control and operation parameters (Puschner et al., 2021). Thus, these parameters and continuous monitoring of the CIED help mitigate heart-related diseases afflicting a patient. Unfortunately, despite their potentially life-saving application, CIEDs are vulnerable to cyber risks.

Cyber Risk. As with any wireless device, CIEDs have over time become increasingly vulnerable to cyber risks. First, in 2008, researchers exhibited one of the first-ever attacks on CIEDs (Rao et al., 2017). Then most strikingly in 2017, the U.S. Food and Drug Administration (FDA) issued a massive recall of CIEDs due to cyber risks potentially depleting the CIEDs' batteries, which may have fatal consequences to a hospital's patients. Thus, these cyber risks put 700,000 patient lives in extreme danger (Skierka, 2018). Consequently, cyber risk continuously poses significant potential liabilities to a hospital. And therefore, hospital risk management teams and decision-makers need to gauge the impact of cyber risk.

Solution To address this pressing issue, we provide a structural framework for liability assessment of cyber risk. Following the structural framework described previously in Section 3, the network is represented as a random star graph that is comprised of a centralized repository at a hospital, represented as the central node, and several CIEDs, represented as connected nodes to the central node. Furthermore, these CIEDs may be implanted in patients of differing age-groups (Eby et al., 2020). Therefore, we define K as the number of different age-groups of patients implanted with CIEDs. This results in a generalized form of the client-server network architecture with the centralized server being the hospital and the clients being the several CIEDs implanted in patients for K number of age-groups.

On this network, the contagion model is defined for the two percolation parameters: p and q. Probability p is defined as the probability of the edge contagion spreading from a CIED to the hospital, while probability q is defined as the probability of the edge contagion spreading from the hospital to a CIED. Furthermore, the probability r is defined as the probability of the contagion starting at the hospital. Additionally, each cyberattack may result in a contagion spreading throughout the network and infecting the CIEDs and the hospital. Consequently, each cyberattack would cause significant financial losses. Therefore, to gauge the impact of cyber risk and for liability assessment, we consider industry informed cost distributions.

Cost distributions. Under the assumption of log-normal distributions, we define the random cost variables C̅₀̅, C̅₁̅, . . . , C̅_̅{̅K̅}̅ for K=5 (we refer the reader to Table 1). These costs materialize when the hospital, described by C̅₀̅ for the permanent data loss of patient records, and the CIEDs, described by C̅₁̅, . . . , C̅₅̅ for the loss of patient lives in each of the age-groups, are infected. The latter cost distributions under consideration are characterized by the means and standard deviations of the value of statistical life of the patient in a given age-group. These cost distributions constitute a cost topology for the network. Thus, with this cost topology, our probabilistic structural framework described in Section 3 provides a liability assessment for cyber risk. To illustrate and visualize our analytical results for liability assessment described in Section 4, we now focus on the numerical implications.

TABLE 1
The expected and deviation of the value of statistical life distributions
by age group with the estimates converted from 2000 USD to 2021
USD (see Aldy and Viscusi (2008)). Additionally, the expected and
deviation of the cost distribution to the hospital for the data loss of
patient records (see Seh et al. (2020)).

| | | Cost (millions USD) | |
|---|---|---|---|
| | Age Group | E(C̅ₗ) | [symbol] |
| C̅₁̅ | 18-24 | 5.98 | 2.78 |
| C̅₂̅ | 25-34 | 15.09 | 1.69 |
| C̅₃̅ | 35-44 | 15.46 | 1.96 |
| C̅₄̅ | 45-54 | 12.91 | 3.40 |
| C̅₅̅ | 55-62 | 5.49 | 0.98 |
| C̅₀̅ | Hospital | 0.429 | 0.06 |

Table 1: The expected and deviation of the value of statistical life distributions by age group with the estimates converted from 2000 USD to 2021 USD (see Aldy and Viscusi (2008)). Additionally, the expected and deviation of the cost distribution to the hospital for the data loss of patient records (see Seh et al. (2020)).

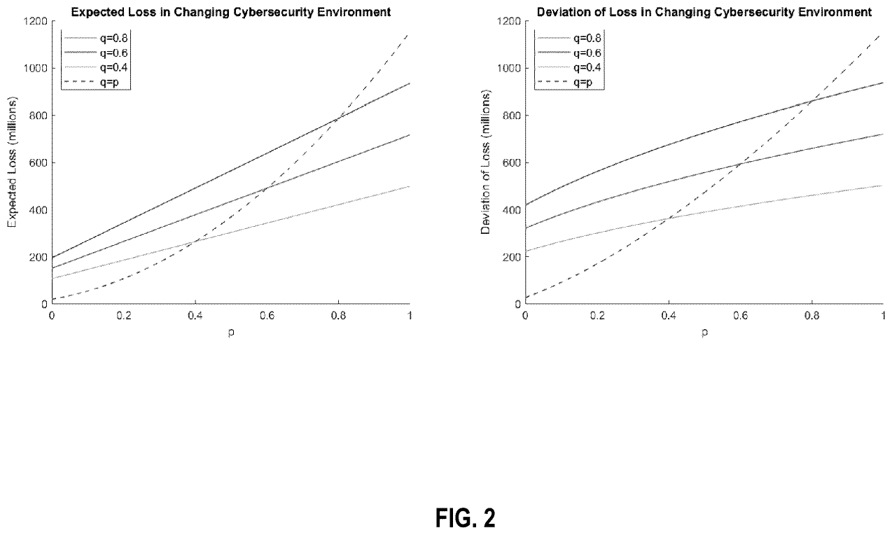

Numerical implications. In this case study, we investigate the effects of the network's cybersecurity environment on the expectation and deviation of loss. As an illustrated example of a cyberattack on the hospital and connected CIEDs, we make the earlier mentioned assumptions outlined at the start of Section 5. Furthermore, we assume the attacks are equally likely to start from a CIED in any age group. Therefore, the probability of the contagion starting at a CIED is uniform with P(Λ=l)=⅕. Furthermore, we consider the size of the network for the number of CIEDs is described by random variable X drawn from a Poisson distribution with mean Λ̅=800, 250 (Pasupula et al., 2019). With these parameters, we investigate the total financial loss as a function of the percolation probability p for various values of the percolation probability q as shown in FIG. 2. Not surprisingly, the loss is nondecreasing with respect to probabilities p and q since lowering the cybersecurity protection i.e. increasing the probability of edge contagion p or q would yield greater losses. This demonstrates that if the network possesses weaker security settings, leading to greater internal risk propagation, the resulting losses would be amplified.

To further explore these findings, we consider three scenarios of a changing cybersecurity environment of the network with respect to the cybersecurity protection of the hospital.
Scenario I. The first scenario considers the network with very low cybersecurity protection for the hospital by fixing r=0.8.
Scenario II. The second scenario considers the network with low cybersecurity protection for the hospital by fixing r=0.6.
Scenario III. The third scenario considers the network with medium cybersecurity protection for the hospital by fixing r=0.4.

Furthermore, within each scenario, we consider a dynamic cybersecurity environment of the network with respect to the network's connections. We investigate two subscenarios of very good cybersecurity protection in one direction of the network and improving cybersecurity protection in the other direction.
Subscenario I fixes the percolation probability q=0.2 as very good cybersecurity protection of the connections from the hospital to the CIEDS. However, the percolation probability p for the connections of the CIEDs toward the hospital varies. Overall, the probability p improves with cybersecurity protection from very low with p=0.8, to low with p=0.6, and finally to medium with p=0.4.
Subscenario II fixes probability p=0.2 as very good cybersecurity protection of the connections of the CIEDs toward the hospital. However, the percolation probability q for the connections of the CIEDs from the hospital varies. Overall, the probability q improves with cybersecurity protection from very low with q=0.8, low with q=0.6, and medium with q=0.4.

With these scenarios and sub-scenarios, we calculate the exact mean and standard deviation of the loss distribution as shown in Table 2, which contains several key insights.

First, increasing the cybersecurity protection, such as implementing effective firewalls for protecting patient health data (Kruse et al., 2017), of the hospital results in lower loss amounts across all scenarios and subscenarios. Second, one can find that in all scenarios and subscenarios fixing probability q with better cybersecurity protection, such as utilizing intrusion detection systems (IDS) (Yan et al., 2015; Siyuan et al., 2001), yields a lower expected deviation of losses compared to fixing p. Hence, investing in better cybersecurity protection in the connections from the hospital results in lower loss amounts compared to the connections toward the hospital. Third, the deviation of the loss has a large dispersion around the mean. This indicates that loss amounts have a large spread and the loss distribution for cyber risk may have a long tail. This corroborates the findings in Eling et al. (2022b). Furthermore, with the provided means and deviations of losses, an insurer can employ known actuarial pricing techniques such as the actuarial fair premium, standard deviation principle, etc. (Embrechts, 2000). However, an insurer should refrain from solely relying on the expectation as the total losses are widespread and thus should consider employing techniques that use the standard deviation.

### 5.2. Modeling Cyber Risk in Smart Buildings

As many are unfortunately well aware, buildings may suffer many types of damage including fire. Just from 2017 to 2019, fire damage cost households $1.7 billion in property losses (United States Fire Administration, 2021), and the trend remains unabated to this day. To reduce losses and mitigate future risks, commercialized buildings are increasingly being integrated with Internet-of-things (IoT) devices, such as smart fire alarms and smoke detectors. However, this increase in integration has also further exposed homes and buildings to cyber risks. Cyber risks can cause integrated IoT devices, such as fire alarms, to become defective, resulting in the inability to prevent fires from causing massive damage. Thus, to mitigate such potential damages, building management teams and associated risk managers need to implement liability frameworks for cyber risk by strategically investing in cybersecurity protection.

Smart building technologies. Traditionally, buildings had separate, independent systems like heating, lighting, and fire safety. IoT integration now unites these systems into a single network, shaping smart buildings. Smart buildings, with a broader scope, leverage AI to prevent fires, reduce costs, and cut energy use (Wendzel et al., 2017). Heating, ventilation, air conditioning (HVAC), and lighting are among the most energy-intensive systems (Berawi et al., 2017). IoT devices like smart thermostats (dos Santos et al., 2020) optimize HVAC energy based on occupancy, even turning off systems in unoccupied rooms through Building Management Systems (BMS), which centralizes the building control (Zou et al., 2018). Furthermore, the BMS adjusts lighting brightness according to daylight (dos Santos et al., 2020), curbing the smart building's carbon footprint (Haidar et al., 2018). Overall, these IoT devices and management systems cut costs, and enhance safety, but their integration raises concerns about growing cyber risks.

TABLE 2
Expectation and deviation of loss for Scenarios I, II, and
III describing a changing cybersecurity environment of
the network by adjusting the probability r of the hospital
being the origin of the contagion. The cost distributions
are from Table 1. The t = 1 and λ = 1 are assumed.

| | | | | Loss (millions USD) | |
|---|---|---|---|---|---|
| | | | | | Standard |
| | | | | Expectation | deviation |
| | Subscenario | p | q | E(L) | \sqrt{Var(L)} |
| Scenario I | I | 0.8 | 0.2 | 213.18 | 222.46 |
| | | 0.6 | 0.2 | 204.46 | 217.48 |
| | | 0.4 | 0.2 | 195.75 | 212.40 |
| | | 0.2 | 0.2 | 187.03 | 207.18 |
| | II | 0.2 | 0.8 | 740.44 | 808.01 |
| | | 0.2 | 0.6 | 555.97 | 607.74 |
| | | 0.2 | 0.4 | 371.50 | 407.47 |
| | | 0.2 | 0.2 | 187.03 | 207.18 |
| Scenario II | I | 0.8 | 0.2 | 206.22 | 219.29 |
| | | 0.6 | 0.2 | 188.79 | 209.08 |
| | | 0.4 | 0.2 | 171.35 | 198.34 |
| | | 0.2 | 0.2 | 153.91 | 186.99 |
| | II | 0.2 | 0.8 | 601.60 | 727.14 |
| | | 0.2 | 0.6 | 452.37 | 547.08 |
| | | 0.2 | 0.4 | 303.14 | 367.03 |
| | | 0.2 | 0.2 | 153.91 | 186.99 |
| Scenario III | I | 0.8 | 0.2 | 199.26 | 216.08 |
| | | 0.6 | 0.2 | 173.11 | 200.32 |
| | | 0.4 | 0.2 | 146.95 | 183.21 |
| | | 0.2 | 0.2 | 120.80 | 164.33 |
| | II | 0.2 | 0.8 | 462.76 | 636.07 |
| | | 0.2 | 0.6 | 348.77 | 478.80 |
| | | 0.2 | 0.4 | 234.79 | 321.55 |
| | | 0.2 | 0.2 | 120.80 | 164.33 |

hospital being the origin of the contagion. The cost distributions are from Table 1. The t=1 and λ=1 are assumed.

Cyber vulnerabilities. Just as with any IoT device in integrated networks, smart building devices have become more vulnerable to disruptive cyberattacks over time. An illustrative case in 2016 saw an Austrian hotel hit by a cyberattack that locked guests out of their rooms (Santos et al., 2020). In the same year, two Finnish apartment buildings faced a chilling cyberattack targeting heating systems, leaving residents in the cold (Santos et al., 2020). Regrettably, many systems within smart buildings, including the BMS, HVAC systems, and fire alarms, continue to exhibit known cyber vulnerabilities (Ciholas et al., 2019). As the BMS's internet connectivity grows, smart buildings face increasing cyber risks (Wendzel et al., 2017). Consequently, smart building cyber risk is a pressing concern, urging building managers and cybersecurity teams to make informed investments in protection.

Cybersecurity protection investment framework. To address this pressing matter, we propose a structural framework for cybersecurity investment in protection strategies. As outlined in Section 3, the network is depicted as a random star with the central BMS and multiple IoT devices connected to it. These IoT devices have specialized functions within specific systems, such as individual fire alarms in an overall fire prevention system. We denote K as the count of distinct connected systems in the smart building. This yields a generalized client-server network setup, where the BMS acts as the centralized server, and the IoT devices across the K systems serve as the clients. Regarding the smart building's network structure, the contagion model involves percolation parameters: p and q. Here, p represents the probability of edge contagion moving from an IoT device to the BMS, while q is the probability of the edge contagion from the BMS to an IoT device. Another factor is r, denoting the probability of BMS-originated contagion.

TABLE 3
The expectation and deviation of energy cost in a smart building for
various connected systems (see Berawi et al. (2017)). Furthermore,
the expectation and deviation of average loss per fire incident in
residential buildings for a faulty fire alarm (see United States
Fire Administration (2021)). can lead to widespread infection across
the smart building, affecting IoT devices and the BMS, which in turn
leads to substantial financial losses. To assess the financial impact
of cyberattacks, we analyze well-informed cost distributions.

Cost USD)

| | | |
|---|---|---|
| System | E(C̅ᵢ) | \sqrt{Var(Cᵢ)} |

| | | | |
|---|---|---|---|
| C̅₀̅ | BMS | 78,956.72 | 0.00 |
| C̅₁̅ | HVAC | 48,381.34 | 0.00 |
| C̅₂̅ | Lighting | 29,058.21 | 0.00 |
| C̅₃̅ | Security | 244.78 | 0.00 |
| C̅₄̅ | Faulty Fire Alarm | 20,492.50 | 17,151.03 |

Costs. We consider random cost variables C̅₀̅, C̅₁̅, . . . , C̅_̅{̅K̅}̅ with K=4 under the assumption of log-normal distributions (see Table 3). These costs materialize when the BMS, described by C̅₀̅, and the IoT devices, described by C̅₁̅, . . . , C̅₄̅ in each of the different systems, are infected. The infection of the BMS, HVAC, lighting, and security systems results in a distribution of increased energy costs. Furthermore, infection of the fire alarm system may result in the inability to prevent a fire. Consequently, the smart building may suffer fire damage resulting in a distribution of financial losses. Therefore, these cost distributions constitute a cost topology for the structural framework. Being able to cost out risks can serve as a resource for prioritizing cybersecurity protection investments and actions to mitigate the risks. Thus, our probabilistic structural framework described in Section 3 provides guidance for cybersecurity protection strategies by modeling the financial losses from a cyberattack.

We now illustrate and visualize the strength of our analytical results described in Section 4 for the exact mean and deviation of loss.

Numerical results. In this case study, we investigate the effects of the smart building's cybersecurity environment on the expectation and deviation of loss. To begin, we make the aforementioned assumptions described at the beginning of Section 5. Moreover, the attacks are equally likely to start from an IoT device in any system. Therefore, the probability of the contagion starting in a system is uniform with

$$P ( Λ = l ) = \frac{1}{4} .$$

In keeping with the generality of the illustrated example, the stylized parameter of the size of the network is described by random variable X drawn from a Poisson distribution with assumed mean λ̅=500.

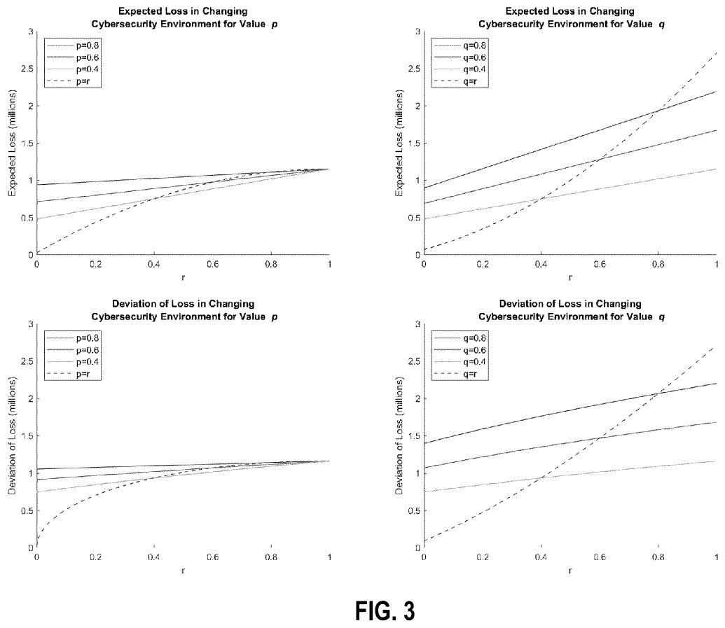

With these parameters, we investigate a changing cybersecurity environment on the smart building network. In particular, we investigate the aggregate exact mean and variance of losses as a function of the probability r for various values of the percolation probabilities p and q. In FIG. 3, adjusting the smart building network's cybersecurity landscape by reducing protection, i.e., increasing probabilities p, q, and r, consistently yields higher losses. This underscores that enhancing cybersecurity through measures, such as network segmentation (National Security Agency, 2019) and administrative privileges (Cybersecurity and Infrastructure Security Agency, 2018) reduce losses while neglecting these measures increases them. Next, altering probability p yields marginal loss differences compared to probability r beyond a certain point for a fixed q. This is evident from the convergence in losses for p, implying limited benefits in bolstering cybersecurity for IoT-to-BMS connections. Conversely, varying q leads to substantial loss variations for a fixed p, highlighted by the disparity in loss expectations and deviations across different q values. Hence, fortifying cybersecurity for BMS-to-IoT connections, e.g., via firewalls, significantly impacts loss distribution. Lastly, fixing q instead of p considerably lowers loss amounts, as evidenced by the comparison of expected and deviation of losses. This further supports the conclusion that thew smart building network's effective cybersecurity investment strategies exhibit notable disparities.

### 5.3. Modeling Cyber Risk in Ride-Sharing Services

Ride-sharing services, such as Uber and Lyft, saw remarkable financial growth, with the global market valued at $73.5 billion in 2020 (Clewlow and Mishra, 2017), projected to reach $343 billion by 2030 (Precedence Research, 2022). This growth hinges on smartphones with global positioning system (GPS) capabilities, but this adoption also exposes ride-sharing to cyber risks. These risks target smartphones and apps used by services and drivers, jeopardizing revenue. Hence, ride-sharing management and risk teams require a cyber-risk-aware loss assessment framework. To avert future losses, informed cybersecurity investment strategies are crucial.

Ride-sharing process and technologies. Ride-sharing involves passengers and drivers sharing trip details with providers like Uber or Lyft. The common process includes account creation via the provider's app for both parties (Clewlow and Mishra, 2017). The provider acts as a link between them, aiding communication (Baza et al., 2020). Passengers then choose ride options with varying fares (Shokoohyar, 2018) and request drivers through the app (Clewlow and Mishra, 2017). Accepted requests give drivers passenger location via GPS (Shokoohyar, 2018). After the ride, payment is made through the app, concluding the process. While this process has created great financial growth, it can pose a significant cyber risk, not only to the service providers but also to the passengers and drivers.

Cyber threats in ride-sharing processes. Smartphones and apps have made centralized ride-sharing susceptible to cyberattacks (Kakkar et al., 2021). For instance, Uber's 2015 data breach exposed data of 57 million users, leading to a $148 million loss in fines and settlements (Baza et al., 2020). Uber also faced a DoS attack disrupting operations and alleged fake ride requests by Lyft (Thai et al., 2018). These attacks reduce both Uber and drivers' earnings, especially in prolonged disruptions. Moreover, drivers' smartphones and ride-sharing apps are vulnerable (National Institute of Standards and Technology, 2019). Exploiting these vulnerabilities could significantly impact providers' and drivers' income. Thus, risk teams and ride-sharing businesses must quantify mean and deviation of cyberattack losses for financial insight and prevention.

Loss framework. Hence, we offer a structural framework for cyber risk loss assessment. Similar to the framework detailed in Section 3, the ride-sharing service network is depicted as a random star graph. This network comprises a central service provider node and connected nodes representing drivers with smartphones. In the context of ride-sharing, drivers offer various ride options. Thus, we denote K as the count of distinct ride options. This framework establishes a generalized client-server network arrangement, where the service provider, such as Uber, is the central server, and the K ride options offered by drivers constitute the diverse clients.

TABLE 4
The expectation and deviation of fare cost from Lyft cost estimates
(see Appendix 7 for sources). Furthermore, the expectation and
deviation of per-record cost to the service-provider due to the
compromise of private data (see IBM Security (2020)).

Fare Cost (USD)

| | Ride Option | E(C̅_{ι}) | \sqrt{Var(Cᵢ)} |
|---|---|---|---|
| C̅₁̅ | Lux | 42.64 | 2.58 |
| C̅₂̅ | Lux Black | 60.85 | 2.96 |
| C̅₃̅ | Lux Black XL | 84.17 | 3.84 |
| C̅₄̅ | Lyft | 22.92 | 1.59 |
| C̅₅̅ | Lyft XL | 34.27 | 2.06 |
| C̅₀̅ | Service Provider | 162.00 | 0.00 |

Furthermore, for the contagion model, probability p is defined as the probability of the edge contagion spreading from a driver's smartphone to the service-provider, such as Uber, while probability q is defined as the probability of the edge contagion spreading from the service-provider to a driver's smartphone. Additionally, the probability r is defined as the probability of the contagion originating in the service provider. And so, the contagion spreading between the service-provider and the drivers' smartphones may cause disruption of services and the compromise of private data. Therefore, for financial loss assessment of cyber risk for ride-sharing services, we consider informed cost distributions.

Cost distributions. Assuming log-normal distributions for costs C̅₀̅, C̅₁̅, . . . , C̅_̅{̅K̅}̅ (with K=5), we analyze costs for ride options and the service provider (Table 4). These costs arise if the service-provider (C̅₀̅) or the drivers' smartphones (C̅₁̅, . . . , C̅₅̅) are compromised. These driver cost distributions depend on ride-option fare means and standard deviations, forming a cost topology. Our structural framework in Section 3 assesses ride-sharing cyber risk liability. For clarity, our analytical results on mean and variance of cyber risk losses in Section 4 are illustrated numerically.

Numerical implications. Here, we demonstrate the implications of the analytical results presented in Section 4 by investigating the financial impact of a changing cybersecurity environment on the connections between the service-provider and its connected drivers. As an illustrated example of a cyberattack on the hospital and connected CIEDs, we adhere to the assumptions previously outlined at the beginning of Section 5. Furthermore, the attacks are equally likely to start from any driver's smartphone device. Therefore, the probability of the contagion originating from a smartphone device within a given ride-option is uniform with

$$P ( Λ = l ) = \frac{1}{5} .$$

For the size of the network, we consider the ride-sharing service Gett, which has a partnership with Lyft in the U.S., with over 100,000 drivers (Gett, 2019; Vonage, 2022). The informed parameter of the number of drivers in the network is described by
random variable X drawn from a Poisson distribution with mean λ̅=100,000.

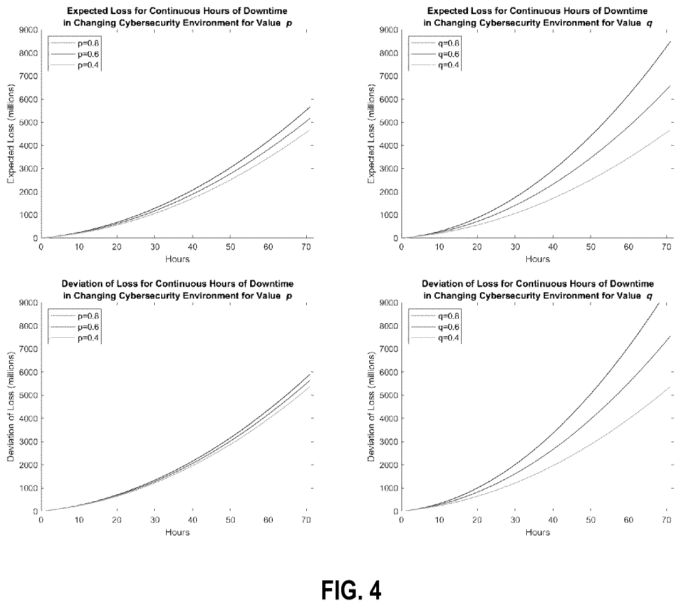

With these parameters, we investigate the financial loss from disruption of operations due to downtime. And so, we consider a changing cybersecurity environment by varying probability p(q) and fixing probability q(p). In FIG. 4, as one would expect, the losses increase as the duration of the disruption due to downtime increases. Therefore, the longer the disruption of business operations, the greater the losses. Furthermore, The financial losses at any hour of downtime are smaller when varying the probability p and fixing probability q with better cybersecurity protection. In other words, this indicates that lowering the value of edge contagion probability q by increasing the cybersecurity protection, such as the use of anti-virus and anti-malware software (Talal et al., 2019), of the connections from the service provider to the smartphone devices may have a larger reduction in total losses.

### 5.4. Modeling Cyber Risk in Vehicle-to-Vehicle Cooperation for Road Space

Traffic congestion wastes time, money, and causes pollution. Beyond stress and costs, it jeopardizes health by exposing commuters to toxic fumes, reducing lifespan (Levy et al., 2010). This leads to 2,200 premature US deaths annually (Harvard School of Public Health, 2011), all due to limited road space. Blockchain offers a solution (MacNeille et al., 2018). Blockchain is an open, distributed ledger recording verifiable transactions (Lakhani and Iansiti, 2017). It uses smart contracts for decentralized tokenized money, defined as digital promises. Blockchain's rapid growth and wide application across industries, including transportation, solve complex issues (Insights, 2016). However, the integration of blockchain also introduces novel cyber risks (Prathap, 2021), risking vehicle disruption and collisions on congested roads. Thus, policy-makers, regulators, and risk teams require cyber risk liability frameworks.

Limited road space solution. Blockchain addresses road traffic and Vehicular Ad-hoc Networks (VANETs) problems. For example, Ford's patent presents the Cooperatively Managed Merge and Pass (CMMP) system, monetizing highway space via vehicle collaboration (MacNeille et al., 2018). CMMP tokens facilitate lane access trading during congestion. It's unclear if it supports cryptocurrencies like Bitcoin or Ethereum, or other manufacturers' vehicles. Ford's patent emphasizes trustworthiness, distinguishing it from other VANETs patents, as blockchain spurs transport innovation while posing safety and financial growth risks.

Cyber risks in blockchain platforms. Blockchain's vulnerability to cyberattacks, including smart contracts, can lead to reversed transactions and double-spending (Medvinsky and Neuman, 1993). A 2016 Ethereum attack stole $50 million (Mehar et al., 2019), followed by a $32 million Parity wallet attack in 2017 (Averin and Averina, 2019). Losses from blockchain attacks surged from $1.49 billion in 2020 to $4.25 billion in 2021 (Prathap, 2021). Popular platforms, such as Ethereum, remain vulnerable (National Institute of Standards and Technology, 2022). Integrating blockchain with vehicles risks driver safety, as cyberattacks may cause vehicle collisions (Greenberg, 2013). With growing vulnerabilities, quantifying cyber risk in this context is crucial.

Mathematical conceptualization. Therefore, we provide a structural framework for the liability assessment of cyber risk for vehicle-to-vehicle cooperation to marshal traffic via monetization of highway space as described in the Ford patent (see (MacNeille et al., 2018)). Following the structural framework described previously in Section 3, the network is defined as a random star graph that is comprised of a central unit, represented as the central node, and vehicles coupled with smart contracts. Furthermore, from following the context of the Ford patent, the network can span a wide geographical area which we partition into K-regions. This results in a generalized client-server network architecture with the central unit and its connected smart contracts among vehicles occurring continuously in the K-regions.

In this generalized client-server network architecture, the contagion model is defined for the two percolation parameters: p and q. Probability p is defined as the probability of the edge contagion spreading from a smart contract to the central unit, while probability q is defined as the probability of the edge contagion spreading from the central unit to a smart contract. Additionally, the probability r is defined as the probability of the contagion starting at the central unit. Furthermore, the contagion spreading throughout the network may cause significant financial losses due to infection of vehicles' smart contracts. Therefore, for liability assessments of cyber risk for vehicle-to-vehicle cooperation, we consider informed costs.

Costs. Considering a wide geographical region, such as Arizona, U.S., we classify its areas into counties. This approach incorporates the costs of cyberattacks causing vehicle collisions. Assuming log-normal distributions for costs C̅₀̅, C̅₁̅, . . . , C̅_̅{̅K̅}̅ (with K=15), we analyze distinct cost distributions across Arizona counties (Table 5). These costs apply if the central unit (C̅₀̅) or the vehicles' smart contracts (C̅₁̅, . . . , C̅₁̅₅̅) are compromised, covering permanent data loss and collision expenses. These county-specific cost distributions involve collision means and standard deviations, forming a cost topology. Our structural framework (refer to Section 3) evaluates cyber risk liability for vehicle-to-vehicle cooperation. We now illustrate the usefulness of our analytical results of the mean and variance of cyber risk losses (refer to Section 4).

Numerical implications. In this case study, we investigate the financial impact of a changing cybersecurity environment on the increasing size of the network. As an illustrated example of a cyberattack on the central unit and the vehicles' smart contracts in the network, we consider the assumptions detailed earlier in Section 5. Furthermore, the attacks are equally likely to start from a smart contract in any county. Therefore, the probability of the contagion originating in a county is uniform with

$$P ( Λ = l ) = \frac{1}{15} .$$

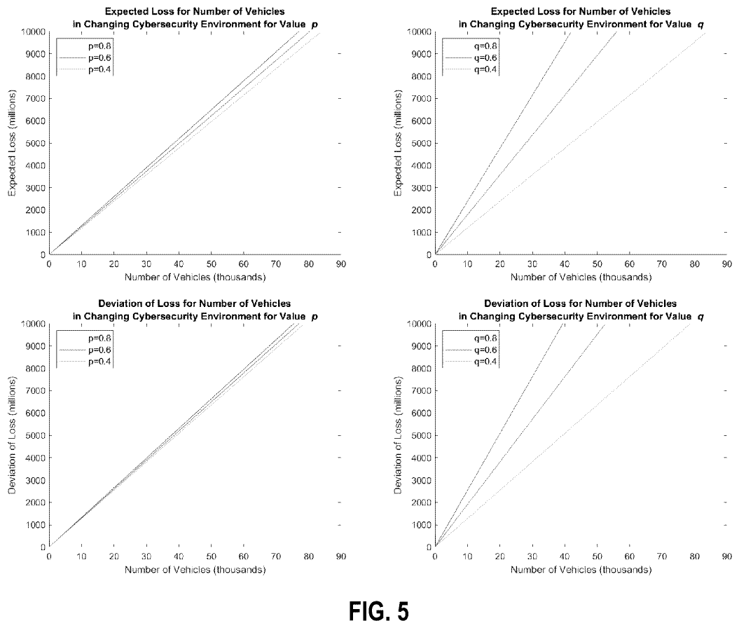

Using the selected parameters, we investigate how altering the network size influences the scale of the loss distribution. Additionally, we study modifications to the cybersecurity network by adjusting p (or q) while keeping q (or p) constant. The graphs in FIG. 5 demonstrate several interesting findings. First, the size of the network, captured by the increasing number of vehicles, consistently leads to higher means and standard deviations of losses. Therefore, the larger the network, the greater the losses. Second, as expected, investing in better cybersecurity protection by lowering the value of probabilities p and q yields lower loss amounts. However, varying the probability p and fixing probability q with better cybersecurity protection results in losses amounting more slowly as more vehicles become vulnerable to cyber risk. Third, the losses are not dramatically different for various values of probability p. However, in contrast, varying probability q and fixing probability p with better cybersecurity protection results in significant differences in loss amounts. This is emphasized by the wide differences in the expectation and deviation of losses between differing values of probability q. Therefore, enhancing the connections from the central unit with better cybersecurity protection, such as the implementation of timely patches and security protocols, may be more impactful in the reduction of the losses than the connections toward the central unit.

TABLE 5
The expectation and deviation of cost from a vehicle collision in each
county in Arizona (see Arizona Department of Transportation (2020)).
For the central unit, the expectation and deviation of permanent data
loss for a single driver record (see IBM Security (2020)).

Fae Cost (USD)

| | County | E(C̅_{ι}) | \sqrt{Var(Cᵢ)} |
|---|---|---|---|
| C̅₁̅ | Apache | 715,984 | 2,308,311 |
| C̅₂̅ | Cochise | 348,462 | 1,692,522 |
| C̅₃̅ | Coconino | 252,784 | 1,332,210 |
| C̅₄̅ | Gila | 342,240 | 1,551,051 |
| C̅₅̅ | Graham | 543,577 | 2,458,125 |
| C̅₆̅ | Greenlee | 90,522 | 124,973 |
| C̅₇̅ | La Paz | 580,756 | 2,113,579 |
| C̅₈̅ | Maricopa | 132,082 | 812,696 |
| C̅₉̅ | Mohave | 289,732 | 1,415,482 |
| C̅₁̅₀̅ | Navajo | 388,587 | 1,869,918 |
| C̅₁̅₁̅ | Pima | 257,276 | 1,320,043 |
| C̅₁̅₂̅ | Pinal | 254,180 | 1,270,558 |
| C̅₁̅₃̅ | Santa Cruz | 375,791 | 2,029,216 |
| C̅₁̅₄̅ | Yavapai | 272,349 | 1,400,042 |
| C̅₁̅₅̅ | Yuma | 223,514 | 1,144,212 |
| C̅₀̅ | Central | 162 | 0 |

### 6. Conclusion

Recent cyberattacks have exhibited the capability to disrupt business operations and cause permanent data loss resulting in significant financial losses to a business. To mitigate such losses, risk managers and decision-makers continuously make decisions that stem from questions on how best to protect their business's IT network. In this paper, we address these questions by providing a liability assessment framework for cyber risk that uniquely incorporates a business's network and cybersecurity environment. In particular, we develop a dynamic structural percolation framework for the aggregate loss distribution with exact mean and standard deviation due to cyberattacks.

Our framework for liability assessments provides practical guidance for cyber risk by investigating four illustrative case studies. With each case study, we make multiple findings. First, as expected, any investment in cybersecurity protection helps mitigate potential losses. Furthermore, we find that risk managers and cybersecurity management may be better positioned to effectively manage a cyberattack by making more investments in the cybersecurity protection of the central server and the connections going away from the central server.

Second, we find that the longer the disruption of business operations due to downtime, the greater the losses. Therefore, for loss mitigation, risk managers and cybersecurity management should reevaluate their network's cybersecurity environment and invest in better cybersecurity protection, especially with the aforementioned cybersecurity strategy, for timely recovery with procedures in place.

Third, we also find that the larger the network, the higher the mean and standard deviation of loss amounts. Therefore, decision-makers should consider comprehensive cyber risk management strategies when taking full advantage of emerging technologies and a growing client base.

Lastly, within each case study, we find that the losses may exhibit a long-tail distribution with given cost distributions. Thus, quantifying cyber risk is not straightforward due to the large dispersion around the mean. To account for this, risk management professionals should consider the broader possible damages a cyberattack may inflict on the business and the corresponding industry sector. Furthermore, ultimately, decision-makers should carefully manage strategies and policies that factor in all the encompassing liabilities of a cyberattack. Additionally, for insurers, certain actuarial pricing principles, such as the expectation principle, may undervalue the losses. Thus, insurers should consider actuarial pricing principles that incorporate the standard deviation of the potential losses.

Furthermore, the mathematical model of the client-server network presented in this work presents a foundation for further research in the micro-level studies of cyber risk. For example, the loss distribution characterization in this work assumes that the consecutive contagions and costs are independent and identically distributed (i.i.d). However, extending this model to relax the i.i.d. assumption, such as using the Hawkes process or a renewal reward process instead of the Poisson process, may be beneficial for modeling dependent consecutive contagions, such as those from the same cybercriminal organization or malicious software tool. In addition, expanding the methodology to account for the heterogeneity of the cost distributions by not having them identically distributed could be useful for capturing nuanced variations between different cyberattacks and time scales. In addition, another layer of complexity can be derived from the assumption that the probability of the origin of the cyberattack is dependent on the size of the network. Lastly, there is potential for calculating the covariance of compromise sizes across the various node types. In the realm of practical applications, the star topology is widely employed, for instance, in domains like smart farming. Therefore, exploring other case studies in such contexts could offer valuable insights for risk managers operating in those fields.

### Appendix: Lyft Cost Estimates

The data to calculate the potential fare of a trip comes from multiple cities. We were able to collect fare estimate data on various cities. These cities include Atlanta, Boston, Buffalo, Chicago, Cleveland, Denver, Indianapolis, Jacksonville, Philadelphia (including South Philadelphia), Phoenix, Pittsburgh, Seattle, and St. Louis. By using each city's associated abbreviation, one can obtain the fare estimated for the given city. For example, the estimated Phoenix area ride costs can be found at Lyft (2022).

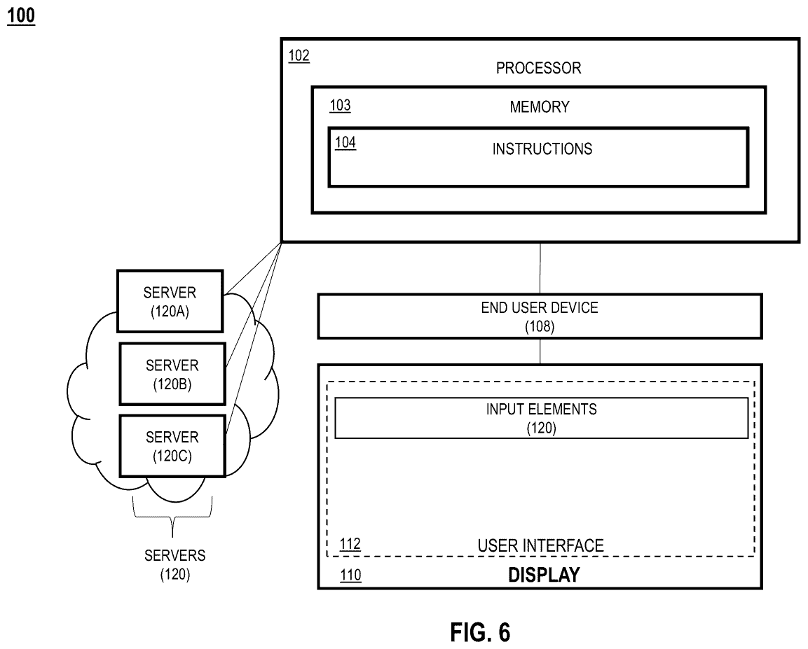

Referring to FIG. 6, embodiments of a system described herein may take the form of a computer-implemented system, designated system 100, configured for computing an aggregate loss distribution for cyber risk of a client-server network architecture with different node types. In general, as indicated, the system 100 includes at least one processor 102 or processing element that is configured for executing functions/operations described herein; e.g., the processor 102 can execute instructions 104 stored in a memory 103 including any form of machine-readable medium. In general, the processor 102, via instructions, accesses input data and is configured to output a mean and variance of the aggregate loss distribution for a client-server random graph associated with the network architecture, among other functions described herein.

The instructions 104 may be implemented as code and/or machine-executable instructions executable by the processor 102 that may represent one or more of a procedure, a function, a subprogram, a program, a routine, a subroutine, a module, an object, a software package, a class, or any combination of instructions, data structures, or program statements, and the like. In other words, one or more of the features for processing described herein may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium (e.g., the memory 103 and/or the memory of computing device 1200), and the processor 102 performs the tasks defined by the code. In some embodiments, the processor 102 is a processing element of a cloud such that the instructions 104 may be implemented via a cloud-based web application.

In some examples, the processor access input data from an end user device 108 in operable communication with a display 110. An end-user, via a user interface 112 rendered along the display 110, can provide input elements 120 to the processor 102 for executing functionality herein. In addition, examples of the system 100 include one or more servers 120 providing access to network architectures, cyber risk information, cyberattack information, and the like.

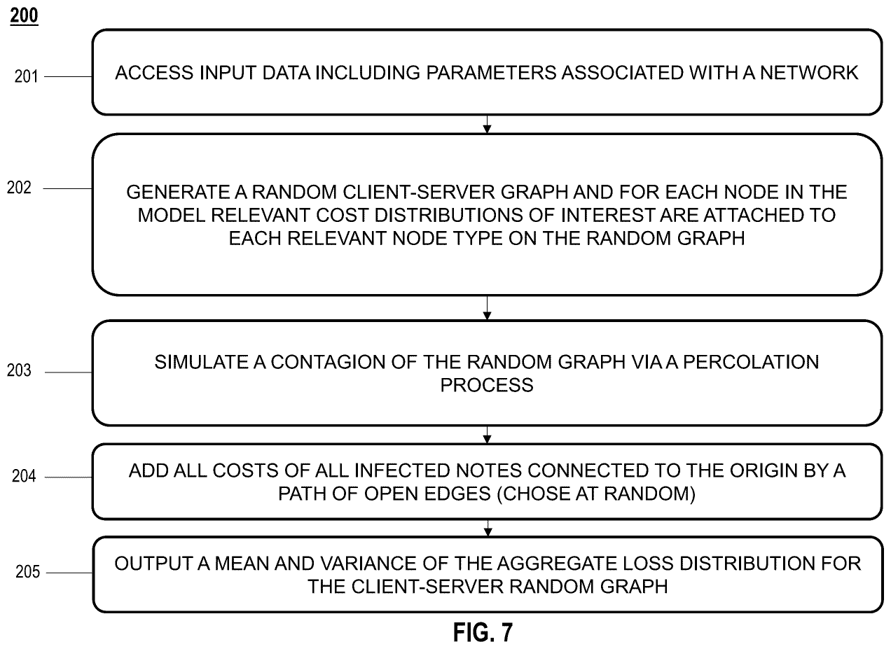

Referring to FIG. 7, an example method and/or computer implemented process 200 is described including (but not limited to) the steps of blocks 201-204.

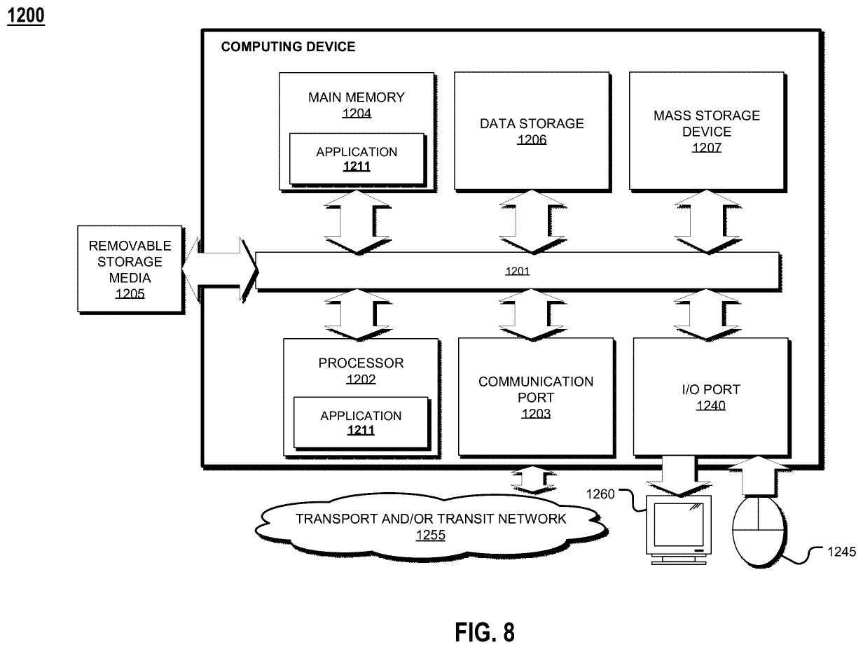

Referring to FIG. 8, a computing device 1200 is illustrated which may be configured, via the instructions 104 and/or other computer-executable instructions, to execute functionality described herein. More particularly, in some embodiments, aspects of the system and/or methods described herein may be translated to software or machine-level code, which may be installed to and/or executed by the computing device 1200 such that the computing device 1200 is configured to functionality described herein. It is contemplated that the computing device 1200 may include any number of devices, such as personal computers, server computers, hand-held or laptop devices, tablet devices, multiprocessor systems, microprocessor-based systems, set top boxes, programmable consumer electronic devices, network PCs, minicomputers, mainframe computers, digital signal processors, state machines, logic circuitries, distributed computing environments, and the like.

The computing device 1200 may include various hardware components, such as a processor 1202, a main memory 1204 (e.g., a system memory), and a system bus 1201 that couples various components of the computing device 1200 to the processor 1202. The system bus 1201 may be any of several types of bus structures including a memory bus or memory controller, a peripheral bus, and a local bus using any of a variety of bus architectures. For example, such architectures may include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computing device 1200 may further include a variety of memory devices and computer-readable media 1207 that includes removable/non-removable media and volatile/nonvolatile media and/or tangible media, but excludes transitory propagated signals. Computer-readable media 1207 may also include computer storage media and communication media. Computer storage media includes removable/non-removable media and volatile/nonvolatile media implemented in any method or technology for storage of information, such as computer-readable instructions, data structures, program modules or other data, such as RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information/data and which may be accessed by the computing device 1200. Communication media includes computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. For example, communication media may include wired media such as a wired network or direct-wired connection and wireless media such as acoustic, RF, infrared, and/or other wireless media, or some combination thereof. Computer-readable media may be embodied as a computer program product, such as software stored on computer storage media.

The main memory 1204 includes computer storage media in the form of volatile/nonvolatile memory such as read only memory (ROM) and random access memory (RAM). A basic input/output system (BIOS), containing the basic routines that help to transfer information between elements within the computing device 1200 (e.g., during start-up) is typically stored in ROM. RAM typically contains data and/or program modules that are immediately accessible to and/or presently being operated on by processor 1202. Further, data storage 1206 in the form of Read-Only Memory (ROM) or otherwise may store an operating system, application programs, and other program modules and program data.

The data storage 1206 may also include other removable/non-removable, volatile/nonvolatile computer storage media. For example, the data storage 1206 may be: a hard disk drive that reads from or writes to non-removable, nonvolatile magnetic media; a magnetic disk drive that reads from or writes to a removable, nonvolatile magnetic disk; a solid state drive; and/or an optical disk drive that reads from or writes to a removable, nonvolatile optical disk such as a CD-ROM or other optical media. Other removable/non-removable, volatile/nonvolatile computer storage media may include magnetic tape cassettes, flash memory cards, digital versatile disks, digital video tape, solid state RAM, solid state ROM, and the like. The drives and their associated computer storage media provide storage of computer-readable instructions, data structures, program modules, and other data for the computing device 1200.

A user may enter commands and information through a user interface 1240 (displayed via a monitor 1260) by engaging input devices 1245 such as a tablet, electronic digitizer, a microphone, keyboard, and/or pointing device, commonly referred to as mouse, trackball or touch pad. Other input devices 1245 may include a joystick, game pad, satellite dish, scanner, or the like. Additionally, voice inputs, gesture inputs (e.g., via hands or fingers), or other natural user input methods may also be used with the appropriate input devices, such as a microphone, camera, tablet, touch pad, glove, or other sensor. These and other input devices 1245 are in operative connection to the processor 1202 and may be coupled to the system bus 1201 but may be connected by other interface and bus structures, such as a parallel port, game port or a universal serial bus (USB). The monitor 1260 or other type of display device may also be connected to the system bus 1201. The monitor 1260 may also be integrated with a touch-screen panel or the like.

The computing device 1200 may be implemented in a networked or cloud-computing environment using logical connections of a network interface 1203 to one or more remote devices, such as a remote computer. The remote computer may be a personal computer, a server, a router, a network PC, a peer device or other common network node, and typically includes many or all of the elements described above relative to the computing device 1200. The logical connection may include one or more local area networks (LAN) and one or more wide area networks (WAN), but may also include other networks. Such networking environments are commonplace in offices, enterprise-wide computer networks, intranets and the Internet.

When used in a networked or cloud-computing environment, the computing device 1200 may be connected to a public and/or private network through the network interface 1203. In such embodiments, a modem or other means for establishing communications over the network is connected to the system bus 1201 via the network interface 1203 or other appropriate mechanism. A wireless networking component including an interface and antenna may be coupled through a suitable device such as an access point or peer computer to a network. In a networked environment, program modules depicted relative to the computing device 1200, or portions thereof, may be stored in the remote memory storage device.

Certain embodiments are described herein as including one or more modules. Such modules are hardware-implemented, and thus include at least one tangible unit capable of performing certain operations and may be configured or arranged in a certain manner. For example, a hardware-implemented module may comprise dedicated circuitry that is permanently configured (e.g., as a special-purpose processor, such as a field-programmable gate array (FPGA) or an application-specific integrated circuit (ASIC)) to perform certain operations. A hardware-implemented module may also comprise programmable circuitry (e.g., as encompassed within a general-purpose processor or other programmable processor) that is temporarily configured by software or firmware to perform certain operations. In some example embodiments, one or more computer systems (e.g., a standalone system, a client and/or server computer system, or a peer-to-peer computer system) or one or more processors may be configured by software (e.g., an application or application portion) as a hardware-implemented module that operates to perform certain operations as described herein.

Accordingly, the term “hardware-implemented module” encompasses a tangible entity, be that an entity that is physically constructed, permanently configured (e.g., hardwired), or temporarily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure the processor 1202, for example, to constitute a particular hardware-implemented module at one instance of time and to constitute a different hardware-implemented module at a different instance of time.

Hardware-implemented modules may provide information to, and/or receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and may store the output of that operation in a memory device to which it is communicatively coupled. A further hardware-implemented module may then, at a later time, access the memory device to retrieve and process the stored output. Hardware-implemented modules may also initiate communications with input or output devices.

Computing systems or devices referenced herein may include desktop computers, laptops, tablets e-readers, personal digital assistants, smartphones, gaming devices, servers, and the like. The computing devices may access computer-readable media that include computer-readable storage media and data transmission media. In some embodiments, the computer-readable storage media are tangible storage devices that do not include a transitory propagating signal. Examples include memory such as primary memory, cache memory, and secondary memory (e.g., DVD) and other storage devices. The computer-readable storage media may have instructions recorded on them or may be encoded with computer-executable instructions or logic that implements aspects of the functionality described herein. The data transmission media may be used for transmitting data via transitory, propagating signals or carrier waves (e.g., electromagnetism) via a wired or wireless connection.

It is believed that the present disclosure and many of its attendant advantages should be understood by the foregoing description, and it should be apparent that various changes may be made in the form, construction, and arrangement of the components without departing from the disclosed subject matter or without sacrificing all of its material advantages. The form described is merely explanatory, and it is the intention of the following claims to encompass and include such changes.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A system for calculating aggregate loss distribution for cyber risk in the class of client-server network architecture, comprising:
a processor configured to perform one or more processes; and
a machine-readable storage medium storing instructions executable by the processor to calculate an aggregate loss distribution associated with a cyberattack in a client-server network architecture having an at least one client type, wherein the processor:
models a plurality of times at which the cyberattack occurs;
creates a random star graph including a plurality of nodes connected by a plurality of edges, wherein the plurality of nodes represents a plurality of clients each having a client type and a central server at the times at which the cyberattack occurs, and each edge of the plurality of edges includes both a probability of infection from the central server to a client and a probability of infection from the client to the central server;
attaches a dynamic value of cost to each node in the probability of nodes according to the client type;
simulates a contagion of a client-server network via a percolation process on the random star graph;
calculates a peripheral size of the contagion starting from a random node;
calculates a peripheral loss and a central loss using the peripheral size of the contagion; and
calculates a total loss and a variation of total loss due to the cyberattack using the random star graph, the peripheral loss, and the central loss.

2. The system of claim 1, wherein the system is industry independent.

3. The system of claim 1, wherein the probability of infection from the central server to the client and the probability of infection from the client to the central server account for a level of existing cybersecurity protection currently in effect.

4. A method for estimating the aggregate loss distribution for cyber risk of a client-server network architecture with different node types, comprising:
accessing input data including parameters associated with a network; and
executing, by a processor, a percolation model configured for cyber risk loss distribution characterization, including:
generating a random client-server graph using the input data;
for each node in the percolation model, attaching cost distributions of interest to each relevant node type on the random client-server graph,
selecting one or more edges to be open at random,
simulating a contagion of the random graph via a percolation process,
adding all of the cost of all the infected nodes connected to the origin by a path of open edges, and
outputting a mean and variance of the aggregate loss distribution for the client-server random graph.

5. The method of claim 4, wherein the input data includes bidirectional bond percolation parameters p and q.

6. The method of claim 4, further comprising:
computing a probability of a contagion starting at a central server r associated with the network.

7. The method of claim 4, further comprising, by execution of the percolation model:
computing a peripheral size of the contagion starting from a random node.

8. The method of claim 4, further comprising, by execution of the percolation model:
computing a peripheral size of the contagion starting from a random node.

9. The method of claim 4, further comprising, by execution of the percolation model: computing a total loss and a variation of total loss due to a cyberattack using the random star graph to derive a peripheral loss and a central loss.

10. The method of claim 4, wherein the edges are selected using Bernoulli samples.

11. The method of claim 4, wherein the input data includes parameters p and q based on cybersecurity network levels associated with the network, a probability of contagion starting at the central server r, relevant cost distributions, a frequency of cyber attacks λ, a number K of client node types, and a distribution of number of client nodes.

12. The method of claim 4, wherein the percolation model calculates a mean and variance of the aggregate loss distribution.
